(19) United States
(12) Patent Application Publication
(10) Pub. No.: US 2026/0095413 A1
(43) Pub. Date: Apr. 2, 2026

(54) ERROR CORRECTION-BASED SCHEDULING FOR WIRELESS COMMUNICATIONS

(71) Applicant: QUALCOMM Incorporated, San Diego, CA (US)

(72) Inventors: Linhai HE, San Diego, CA (US); Liangping MA, San Diego, CA (US)

(21) Appl. No.: 19/341,843

(22) Filed: Sep. 26, 2025

Related U.S. Application Data
(60) Provisional application No. 63/702,138, filed on Oct. 1, 2024.

(51) Int. Cl. H04L 47/24; H04L 1/00

(52) U.S. Cl. CPC H04L 47/24; H04L 1/0061; H04L 1/0048

(57) ABSTRACT

Methods, systems, and devices for wireless communications are described. A network entity may obtain forward error correction (FEC) encoding information for data packets associated with a traffic flow of a user equipment (UE), schedule communication of the data packets based on the FEC encoding information, and communicate the data packets with the UE based on the scheduling and FEC encoding information. The FEC encoding information may indicate that the data packets are FEC encoded, an identifier of the traffic flow, and one or more encoding parameters of the data packets. The network entity may obtain the FEC encoding information from a user plane function (UPF), an access and mobility function (AMF), the UE, or a policy control function (PCF). Based on the FEC encoding information, the network entity may schedule the data packets across different carriers, cell groups, transport blocks (TBs), code blocks (CBs), or code block groups (CBGs).

### CROSS REFERENCES

The present Application for Patent claims benefit of U.S. Provisional Patent Application No. 63/702,138 by HE et al., entitled “ERROR CORRECTION-BASED SCHEDULING FOR WIRELESS COMMUNICATIONS,” filed Oct. 1, 2024, assigned to the assignee hereof, and hereby expressly incorporated by reference herein in its entirety as if fully set forth below and for all applicable purposes.

### FIELD OF TECHNOLOGY

The following relates to wireless communications, including error correction-based scheduling for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include obtaining forward error correction (FEC) encoding information for data packets associated with a traffic flow of a user equipment (UE), the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, transmitting control signaling that schedules communication of the data packets associated with the traffic flow for the UE based on the FEC encoding information, and communicating the data packets associated with the traffic flow with the UE based on the control signaling and the FEC encoding information.

A network entity for wireless communications is described. The network entity may include one or more memories storing processor executable code, and one or more processors coupled with the one or more memories. The one or more processors may individually or collectively be operable to execute the code to cause the network entity to obtain FEC encoding information for data packets associated with a traffic flow of a UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, transmit control signaling that schedules communication of the data packets associated with the traffic flow for the UE based on the FEC encoding information, and communicate the data packets associated with the traffic flow with the UE based on the control signaling and the FEC encoding information.

Another network entity for wireless communications is described. The network entity may include means for obtaining FEC encoding information for data packets associated with a traffic flow of a UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, means for transmitting control signaling that schedules communication of the data packets associated with the traffic flow for the UE based on the FEC encoding information, and means for communicating the data packets associated with the traffic flow with the UE based on the control signaling and the FEC encoding information.

A non-transitory computer-readable medium storing code for wireless communications is described. The code may include instructions executable by one or more processors to obtain FEC encoding information for data packets associated with a traffic flow of a UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, transmit control signaling that schedules communication of the data packets associated with the traffic flow for the UE based on the FEC encoding information, and communicate the data packets associated with the traffic flow with the UE based on the control signaling and the FEC encoding information.

In some examples of the method, network entities, and non-transitory computer-readable medium described herein, obtaining the FEC encoding information may include operations, features, means, or instructions for receiving, from the UE, assistance information including the FEC encoding information.

In some examples of the method, network entities, and non-transitory computer-readable medium described herein, obtaining the FEC encoding information may include operations, features, means, or instructions for receiving, from a policy control function (PCF) of a core network, an indication of the FEC encoding information via an application function associated with the data packets.

In some examples of the method, network entities, and non-transitory computer-readable medium described herein, obtaining the FEC encoding information may include operations, features, means, or instructions for receiving, from a user plane function (UPF) of a core network, the FEC encoding information via a session management function (SMF) of the core network.

In some examples of the method, network entities, and non-transitory computer-readable medium described herein, obtaining the FEC encoding information may include operations, features, means, or instructions for receiving, from an access and mobility management function (AMF) of a core network, the FEC encoding information via a network exposure function (NEF) of the core network, a PCF of the core network, or both.

In some examples of the method, network entities, and non-transitory computer-readable medium described herein, the control signaling that schedules the communication of the data packets associated with the traffic flow indicates a set of multiple carriers, a set of multiple cell groups, or a combination thereof, based on the FEC encoding information.

In some examples of the method, network entities, and non-transitory computer-readable medium described herein, communicating the data packets associated with the traffic flow may include operations, features, means, or instructions for receiving a first packet of the data packets in a first carrier of the set of multiple carriers or a first cell group of the set of multiple cell groups based on the control signaling and the FEC encoding information and receiving a second packet of the data packets in a second carrier of the set of multiple carriers or a second cell group of the set of multiple cell groups based on the control signaling and the FEC encoding information.

In some examples of the method, network entities, and non-transitory computer-readable medium described herein, the control signaling that schedules the communication of the data packets associated with the traffic flow indicates a set of multiple transport blocks that are each associated with a respective multiple-input multiple-output (MIMO) communication layer based on the FEC encoding information and a capability of the UE to support MIMO operations.

In some examples of the method, network entities, and non-transitory computer-readable medium described herein, communicating the data packets associated with the traffic flow may include operations, features, means, or instructions for receiving a first data packet of the data packets in a first transport block of the set of multiple transport blocks associated with a first MIMO communication layer based on the control signaling and the FEC encoding information and receiving a second data packet of the data packets in a second transport block of the set of multiple transport blocks associated with a second MIMO communication layer based on the control signaling and the FEC encoding information.

In some examples of the method, network entities, and non-transitory computer-readable medium described herein, the control signaling that schedules the communication of the data packets associated with the traffic flow indicates a set of multiple code blocks associated with one or more code block groups based on the FEC encoding information and a first code block of the set of multiple code blocks may be associated with a first subcarrier and a second code block of the set of multiple code blocks may be associated with a second subcarrier.

In some examples of the method, network entities, and non-transitory computer-readable medium described herein, communicating the data packets associated with the traffic flow may include operations, features, means, or instructions for receiving a first data packet of the data packets in the first code block based on the control signaling and the FEC encoding information and receiving a second data packet of the data packets in the second code block based on the control signaling and the FEC encoding information.

In some examples of the method, network entities, and non-transitory computer-readable medium described herein, the set of multiple code blocks may be associated with one or more transport blocks indicated by the control signaling.

In some examples of the method, network entities, and non-transitory computer-readable medium described herein, the one or more encoding parameters of the data packets associated with the traffic flow may indicate a ratio of a first quantity of the data packets to a second quantity of FEC encoded packets used to communicate the data packets and the second quantity may be larger than the first quantity.

A method for wireless communications by a UE is described. The method may include transmitting FEC encoding information for data packets associated with a traffic flow of the UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, receiving control signaling that schedules transmission of the data packets associated with the traffic flow to a network entity based on the FEC encoding information, and transmitting the data packets associated with the traffic flow to the network entity based on the control signaling and the FEC encoding information.

A UE for wireless communications is described. The UE may include one or more memories storing processor executable code, and one or more processors coupled with the one or more memories. The one or more processors may individually or collectively be operable to execute the code to cause the UE to transmit FEC encoding information for data packets associated with a traffic flow of the UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, receive control signaling that schedules transmission of the data packets associated with the traffic flow to a network entity based on the FEC encoding information, and transmit the data packets associated with the traffic flow to the network entity based on the control signaling and the FEC encoding information.

Another UE for wireless communications is described. The UE may include means for transmitting FEC encoding information for data packets associated with a traffic flow of the UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, means for receiving control signaling that schedules transmission of the data packets associated with the traffic flow to a network entity based on the FEC encoding information, and means for transmitting the data packets associated with the traffic flow to the network entity based on the control signaling and the FEC encoding information.

A non-transitory computer-readable medium storing code for wireless communications is described. The code may include instructions executable by one or more processors to transmit FEC encoding information for data packets associated with a traffic flow of the UE, the FEC encoding information including at least an identifier of the traffic flow and one or more encoding parameters of the data packets associated with the traffic flow, where the FEC encoding information indicates that the data packets associated with the traffic flow are encoded according to a FEC encoding scheme, receive control signaling that schedules transmission of the data packets associated with the traffic flow to a network entity based on the FEC encoding information, and transmit the data packets associated with the traffic flow to the network entity based on the control signaling and the FEC encoding information.

In some examples of the method, UEs, and non-transitory computer-readable medium described herein, transmitting the FEC encoding information may include operations, features, means, or instructions for transmitting assistance information associated with the UE to a network entity, where the assistance information includes the FEC encoding information.

Some examples of the method, UEs, and non-transitory computer-readable medium described herein may further include operations, features, means, or instructions for receiving, from an application client, the FEC encoding information, where the assistance information includes the FEC encoding information received from the application client.

In some examples of the method, UEs, and non-transitory computer-readable medium described herein, the FEC encoding information may be transmitted via an application function associated with the data packets to a PCF of a core network.

In some examples of the method, UEs, and non-transitory computer-readable medium described herein, the control signaling that schedules the transmission of the data packets associated with the traffic flow indicates a set of multiple carriers, a set of multiple cell groups, or a combination thereof, based on the FEC encoding information.

In some examples of the method, UEs, and non-transitory computer-readable medium described herein, transmitting the data packets associated with the traffic flow may include operations, features, means, or instructions for transmitting a first packet of the data packets in a first carrier of the set of multiple carriers or a first cell group of the set of multiple cell groups based on the control signaling and the FEC encoding information and transmitting a second packet of the data packets in a second carrier of the set of multiple carriers or a second cell group of the set of multiple cell groups based on the control signaling and the FEC encoding information.

In some examples of the method, UEs, and non-transitory computer-readable medium described herein, the control signaling that schedules the transmission of the data packets associated with the traffic flow indicates a set of multiple transport blocks that are each associated with a respective MIMO communication layer based on the FEC encoding information and a capability of the UE to support MIMO operations.

In some examples of the method, UEs, and non-transitory computer-readable medium described herein, transmitting the data packets associated with the traffic flow may include operations, features, means, or instructions for transmitting a first data packet of the data packets in a first transport block of the set of multiple transport blocks associated with a first MIMO communication layer based on the control signaling and the FEC encoding information and transmitting a second data packet of the data packets in a second transport block of the set of multiple transport blocks associated with a second MIMO communication layer based on the control signaling and the FEC encoding information.

In some examples of the method, UEs, and non-transitory computer-readable medium described herein, the control signaling that schedules the transmission of the data packets associated with the traffic flow indicates a set of multiple code blocks associated with one or more code block groups based on the FEC encoding information and a first code block of the set of multiple code blocks may be associated with a first subcarrier and a second code block of the set of multiple code blocks may be associated with a second subcarrier.

In some examples of the method, UEs, and non-transitory computer-readable medium described herein, transmitting the data packets associated with the traffic flow may include operations, features, means, or instructions for transmitting a first data packet of the data packets in the first code block based on the control signaling and the FEC encoding information and transmitting a second data packet of the data packets in the second code block based on the control signaling and the FEC encoding information.

In some examples of the method, UEs, and non-transitory computer-readable medium described herein, the set of multiple code blocks may be associated with one or more transport blocks indicated by the control signaling.

In some examples of the method, UEs, and non-transitory computer-readable medium described herein, the one or more encoding parameters of the data packets associated with the traffic flow may be a ratio of a first quantity of data packets to a second quantity of FEC encoded packets used to communicate the data packets and the second quantity may be larger than the first quantity.

Some examples of the method, UEs, and non-transitory computer-readable medium described herein may further include operations, features, means, or instructions for performing a logical channel prioritization procedure on transmission resources indicated by the control signaling to determine whether the data packets encoded according to the FEC encoding scheme may be eligible to be transmitted via the transmission resources, where the data packets may be transmitted based on the logical channel prioritization procedure.

Some examples of the method, UEs, and non-transitory computer-readable medium described herein may further include operations, features, means, or instructions for determining a quantity of transmission resources indicated by the control signaling for transmission of the data packets, where a transmission resource of the transmission resources may be a transport block scheduled in a carrier or in a cell group, a transport block associated with a respective MIMO communication layer, a code block or code block group within a transport block, or any combination thereof, where the data packets may be transmitted based on the quantity of the transmission resources.

In some examples of the method, UEs, and non-transitory computer-readable medium described herein, determining the quantity of the transmission resources indicated by the control signaling may include operations, features, means, or instructions for multiplying a first quantity of transport blocks that may be associated with different MIMO communication layers by a second quantity of code blocks within each transport block.

In some examples of the method, UEs, and non-transitory computer-readable medium described herein, transmitting the data packets associated with the traffic flow may include operations, features, means, or instructions for transmitting the data packets associated with the traffic flow amongst the transmission resources based on a hashing function associated with sequence numbers of the data packets.

In some examples of the method, UEs, and non-transitory computer-readable medium described herein, the hashing function may be based on a modulo operation performed on the sequence numbers of the data packets.

In some examples of the method, UEs, and non-transitory computer-readable medium described herein, the modulo operation receives one or more carrier indices as inputs based on a set of multiple carriers, a set of multiple cell groups, or both, indicated by the control signaling.

In some examples of the method, UEs, and non-transitory computer-readable medium described herein, transmitting the data packets associated with the traffic flow may include operations, features, means, or instructions for transmitting the data packets associated with the traffic flow amongst the quantity of the transmission resources based on a common probability factor that each data packet of the data packets will be transmitted within a transmission resource of the transmission resources, where the common probability factor may be an inverse of a quantity of FEC encoded packets that carries the data packets.

In some examples of the method, UEs, and non-transitory computer-readable medium described herein, transmitting the data packets associated with the traffic flow may include operations, features, means, or instructions for transmitting a first radio link control (RLC) segment of a data packet of the data packets in a remaining available portion of a transmission resource of the transmission resources based on a first size of the first RLC segment being equal to a second size of the remaining available portion and buffering one or more second RLC segments of the data packet for transmission in a second transmission resources indicated by second control information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports error correction-based scheduling for wireless communications in accordance with one or more aspects of the present disclosure.

FIGS. 2 and 3 show examples of process flows that support error correction-based scheduling for wireless communications in accordance with one or more aspects of the present disclosure.

FIGS. 4 and 5 show block diagrams of devices that support error correction-based scheduling for wireless communications in accordance with one or more aspects of the present disclosure.

FIG. 6 shows a block diagram of a communications manager that supports error correction-based scheduling for wireless communications in accordance with one or more aspects of the present disclosure.

FIG. 7 shows a diagram of a system including a device that supports error correction-based scheduling for wireless communications in accordance with one or more aspects of the present disclosure.

FIGS. 8 and 9 show block diagrams of devices that support error correction-based scheduling for wireless communications in accordance with one or more aspects of the present disclosure.

FIG. 10 shows a block diagram of a communications manager that supports error correction-based scheduling for wireless communications in accordance with one or more aspects of the present disclosure.

FIG. 11 shows a diagram of a system including a device that supports error correction-based scheduling for wireless communications in accordance with one or more aspects of the present disclosure.

FIGS. 12 and 13 show flowcharts illustrating methods that support error correction-based scheduling for wireless communications in accordance with one or more aspects of the present disclosure.

### DETAILED DESCRIPTION

In some wireless communications systems, a network entity may communicate (e.g., receive, transmit) one or more data packets (e.g., protocol data units (PDUs)) that are encoded (e.g., carrying data that is encoded) according to a forward error correction (FEC) encoding scheme. For example, encoding data packets according to the FEC encoding scheme may mitigate the negative effects of dynamic wireless connection quality on the data packets by encoding a first quantity of original data packets into a second quantity of FEC encoded (e.g., FEC protected) data packets, where the second quantity is larger than the first quantity, and where a receiver may successfully decode the original data packets by receiving at least the first quantity of the FEC encoded data packets. Although a redundancy of FEC encoded data packets may add robustness to the communication of the data packets, a traffic flow (e.g., a quality of service (QoS) flow, a set of data packets associated with a same latency parameter) that includes the FEC encoded data packets may be communicated over the same (e.g., non-diversified) radio resources (e.g., a same transport block (TB), a same code block (CB), a same carrier, same frequency resources), which may reduce the benefits of FEC by subjecting each FEC encoded data packets to the same dynamic connection quality. The network entity may not be aware of which traffic flows include FEC encoded data packets, and thus may not be capable of scheduling FEC encoded data packets for communication via diverse radio resources. Thus, techniques to increase radio resource diversity for FEC encoded traffic flows may be beneficial.

According to techniques described herein, a network entity may obtain FEC encoding information for data packets associated with a traffic flow of a user equipment (UE), schedule communication of the data packets based on the FEC encoding information, and communicate the data packets with the UE based on the scheduling and the FEC encoding information. For example, the FEC encoding information may indicate that the data packets of the traffic flow are FEC encoded (e.g., implicitly or explicitly), and the FEC encoding information may include at least an identifier of the traffic flow and one or more encoding parameters (e.g., an encoding rate) of the data packets. For downlink communication of the data packets (e.g., transmitting the data packets from the network entity to the UE), a user plane function (UPF) or an access and mobility function (AMF) of a core network may output (e.g., transmit) the FEC encoding information to the network entity. For uplink communication of the data packets (e.g., transmitting the data packets from the UE to the network entity), the UE or a policy control function (PCF) of the core network may transmit (e.g., output) the FEC encoding information to the network entity.

In some cases, in response to obtaining the FEC encoding information for the data packets of the traffic flow, the network entity may schedule the communication of the data packets (e.g., the FEC encoded data packets) across different carriers or cell groups, across different TBs, across different CBs or code block groups (CBGs), or any combination thereof. For uplink communication of the data packets, the UE may determine a quantity of transmission resources (e.g., TBs, CBs, CBGs) scheduled by the network entity for transmission of the data packets and may distribute the transmission of the data packets amongst the transmission resources based on a hashing function or a random selection using a common probability factor. Accordingly, the network entity (e.g., and the UE) may communicate FEC encoded data packets via diversified radio resources, increasing communication quality in the wireless communications system.

Aspects of the disclosure are initially described in the context of wireless communications systems. Aspects of the disclosure are also described with respect to process flows. Aspects of the disclosure are further illustrated by and described with reference to apparatus diagrams, system diagrams, and flowcharts that relate to error correction-based scheduling for wireless communications.

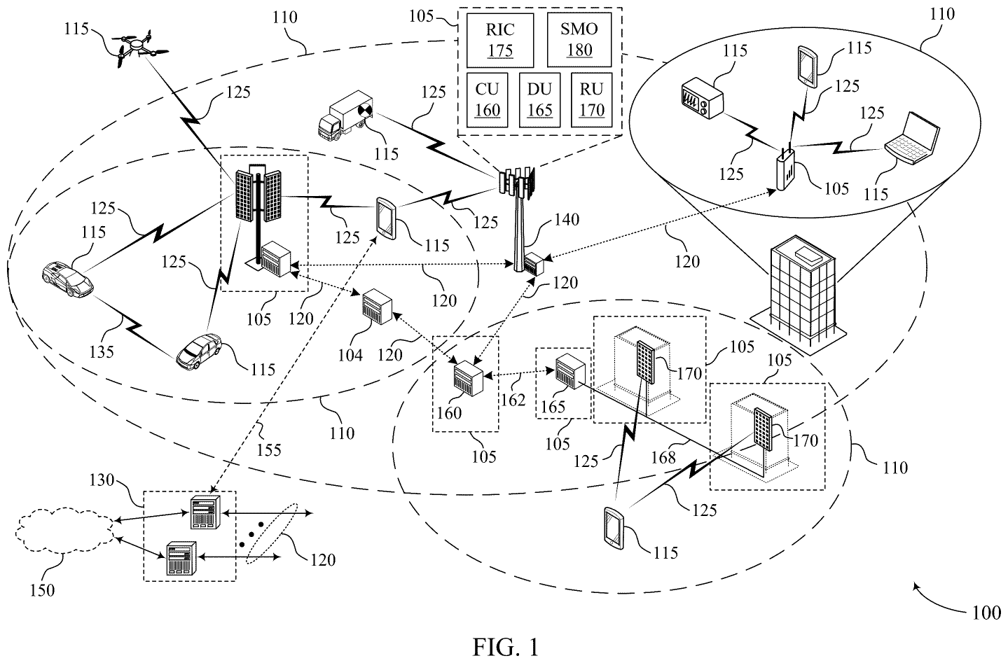

FIG. 1 shows an example of a wireless communications system 100 that supports error correction-based scheduling for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support error correction-based scheduling for wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1. In some cases, the UEs 115 may receive data from server devices (e.g., not shown) via the network entities 105.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. The core network 130 may also include one or more of a PCF (e.g., to manage policies that control network behavior, such as quality of service (QoS), network resource allocation, authentication, mobility, security, network slicing, and roaming), a session management function (SMF) (e.g., to manage user sessions and connectivity, including setting up, modifying, and releasing sessions, managing the user plane for connectivity, allocating IP addresses for IP PDU sessions, enforcing QoS policies between services, collecting charging data, controlling charging functionality, enabling mobility handover between communication technologies (e.g., between LTE, 4G, 5G)), and a network exposure function (NEF) (e.g., to provide a secure access to network services and capabilities for third-party developers and enterprises). User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

According to techniques described herein, a network entity 105 may obtain FEC encoding information for data packets associated with a traffic flow of a UE 115, schedule communication of the data packets (e.g., with the UE 115) based on the FEC encoding information, and communicate the data packets with the UE 115 based on the scheduling and FEC encoding information. For example, the FEC encoding information may indicate that the data packets of the traffic flow are FEC encoded, and the FEC encoding information may include at least an identifier of the traffic flow and one or more encoding parameters of the data packets. For downlink communication of the data packets, the UPF or the AMF of the core network 130 may output (e.g., transmit) the FEC encoding information to the network entity 105. For uplink communication of the data packets, the UE 115 or the PCF of the core network 130 may transmit (e.g., output) the FEC encoding information to the network entity 105.

In response to obtaining the FEC encoding information for the data packets associated with the traffic flow, the network entity 105 may schedule the communication of the data packets (e.g., the FEC encoded data packets) across different carriers or cell groups, across different TBs, across different CBs or CBGs, or any combination thereof. For uplink communication of the data packets, the UE 115 may determine a quantity of transmission resources (e.g., TBs, CBs, CBGs) scheduled for transmission of the data packets and may distribute the transmission of the data packets amongst the transmission resources based on a hashing function or a random selection using a common probability factor. Accordingly, the network entity 105 (e.g., and the UE 115) may communicate FEC encoded data packets via diversified radio resources, increasing communication quality in the wireless communications system 100.

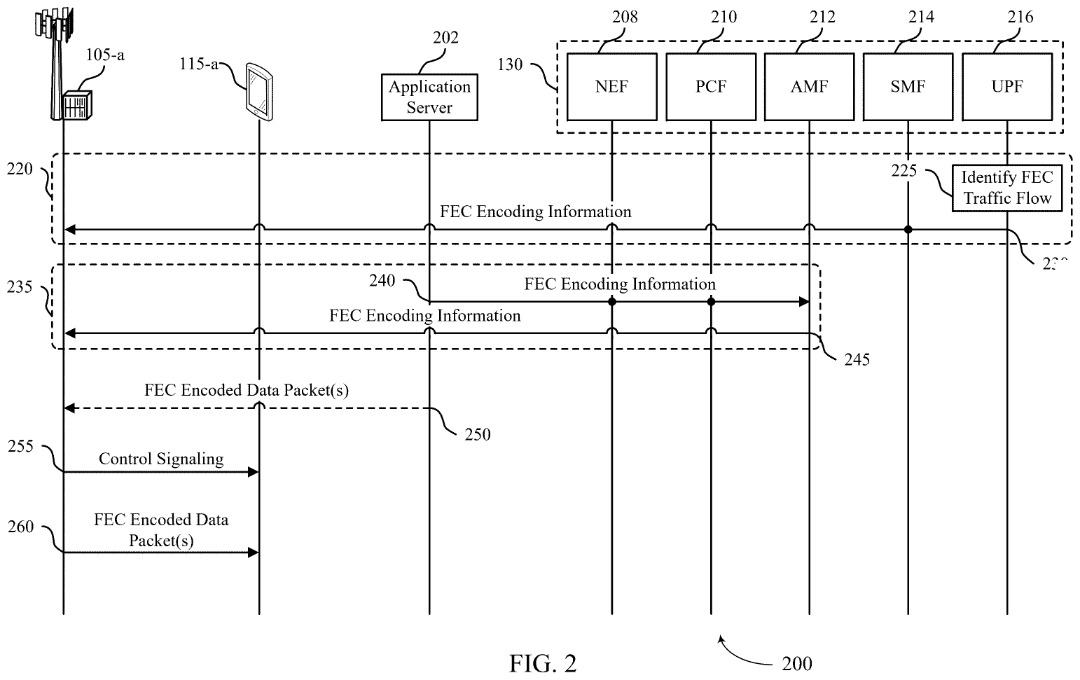

FIG. 2 shows an example of a process flow 200 that supports error correction-based scheduling for wireless communications in accordance with one or more aspects of the present disclosure. In some cases, aspects of the process flow 200 may implement or be implemented by aspects of FIG. 1. For example, the process flow 200 may include a network entity 105-a (e.g., an example of the network entities 105 described with respect to FIG. 1), a UE 115-a (e.g., an example of the UEs 115 as described with respect to FIG. 1), and one or more functions of the core network 130 (e.g., an NEF 208, a PCF 210, an AMF 212, an SMF 214, and a UPF 216, as described with respect to FIG. 1, which may be implemented as hardware, software, or both, of a network entity 105 or other network device described with respect to FIG. 1). The process flow 200 may also include an application server 202. In some aspects, the process flow 200 may illustrate techniques for error correction-based scheduling for downlink communication, where the network entity 105-a may obtain the FEC encoding information for data packets associated with a traffic flow from one or more functions of the core network 130 and may transmit the data packets to the UE 115-a based on the FEC encoding information.

In the following description of process flow 200, the operations may be performed in a different order than the order shown, or other operations may be added or removed from the process flow 200. For example, some operations may be left out of process flow 200, may be performed in different orders or at different times, or other operations may be added to process flow 200. Although the UE 115-a, the network entity 105-a, the application server 202, the NEF 208, the PCF 210, the AMF 212, the SMF 214, and the UPF 216 are shown performing the operations of process flow 200, some aspects of some operations may also be performed by one or more other wireless devices or network devices (e.g., as described with respect to FIG. 1).

In some cases, the UE 115-a may support an FEC encoding scheme (e.g., an application-level FEC (AL-FEC) scheme, FEC). For example, some applications (e.g., extended reality (XR), virtual reality (VR)) may encode data using FEC (e.g., Raptor code) to mitigate the negative effects of dynamic variations in a quality of network connections and provide a more consistent user experience at the UE 115-a. Implementing the FEC encoding scheme may include encoding (e.g., by a transmitting entity or source entity) a first quantity (e.g., K) of original (e.g., not encoded) data packets into a second quantity (e.g., N) of FEC encoded (e.g., FEC protected) data packets, where the second quantity is greater than the first quantity (e.g., where N>K, and where N and K may represent positive integers). For data packets encoded using maximum distance separable (MDS) codes, a receiver of the FEC encoded data packets may decode the original K data packets based on receiving any K out of the N FEC encoded data packets.

In some cases, different FEC encoded data packets of a same data block (e.g., of a PDU set) may be communicated via the same radio resources (e.g., carrier, frequency resources, TB, CB, CBG), which may limit the effectiveness of the FEC encoding scheme. For example, using non-diversified radio resources to communicate the FEC encoded data packets may cause each FEC encoded data packet to be subjected to the same communication conditions, increasing a likelihood that the receiver may fail to receive more than the difference between N and K of the FEC encoded data packets. In some wireless communications systems, the network entity 105-a may not be aware of which traffic flows include FEC encoded data packets, and thus the network entity 105-a may not be able to schedule diversified radio resources for the FEC encoded data packets (e.g., provide differentiated handling of FEC encoded data packets versus original (e.g., non-FEC encoded) data packets). Additionally, data packets (e.g., PDUs) in a same traffic flow (e.g., QoS flow) may be handled in the same way (e.g., communicated via the same resources), resulting in a limited quantity of mechanisms to create diversity in the transmission of the data packets.

Thus, to increase the diversity and effectiveness of FEC encoded data packet communication in a wireless communications system, the network entity 105-a (e.g., the RAN) may obtain FEC encoding information for one or more data packets associated with a traffic flow of the UE 115-a. For example, the FEC encoding information may indicate to the network entity 105-a whether a traffic flow (e.g., a QoS flow, one or more data packets in the traffic flow) is encoded according to the FEC encoding scheme to enable to network entity 105-a to provide more diverse radio resources for communicating the traffic flow. The FEC encoding information may indicate whether the traffic flow is FEC encoded implicitly (e.g., reception of the FEC information for a traffic flow indicates that it is FEC encoded) or explicitly (e.g., a field in the FEC encoding information indicates whether one or more data packets associated with a traffic flow are FEC encoded).

Additionally, the FEC encoding information may include other information. For example, the FEC encoding information may include at least a traffic flow identifier (e.g., an index of the traffic flow, a unique identifier of the traffic flow), one or more FEC encoding parameters associated with the traffic flow, or both. For example, the one or more FEC encoding parameters may include an FEC encoding ratio of the traffic flow, which may indicate a ratio of original data packets (e.g., non-encoded data packets) to FEC encoded data packets (e.g., K/N). In some cases, the FEC encoding information may be included in an information element of one or more control messages, or signaled within other preexisting signaling.

The process flow 200 illustrates the techniques of this disclosure in the context of downlink communication (e.g., the data packets associated with the traffic flow may be transmitted from the network entity 105-a to the UE 115-a). Thus, the process flow 200 may illustrate the network entity 105-a obtaining the FEC encoding information from one or more functions of the core network 130. For example, the operations within signal flow operations 220 and signal flow operations 235 may be examples of obtaining the FEC encoding information at the network entity 105-a. That is, the signal flow operations 220 and the signal flow operations 235 may be alternative or additional operation, and one or more of the signal flow operations 220 and the signal flow operations 235 may occur for the network entity 105-a to obtain the FEC encoding information for the data packets associated with the traffic flow of the UE 115-a.

For example, at 225 (e.g., a first operation of the signal flow operations 220) the UPF 216 may identify whether a traffic flow (e.g., one or more data packets in the traffic flow) is encoded using FEC. For example, identifying whether a traffic flow is FEC encoded may identifying and FEC identifier in one or more data packets associated with a traffic flow, recognizing an FEC encoding structure in one or more data packets associated with a traffic flow, or both. The UPF 216 may generate FEC encoding information associated with the traffic flow, and, at 230 (e.g., a second operation of the signal flow operations 220), the UPF 216 may inform the SMF 214 of the FEC encoding information in response to identifying whether the traffic flow is encoded according to FEC. The SMF 214 may then inform the network entity 105-a of the FEC encoding information associated with the traffic flow. That is, the network entity 105-a may receive, from the UPF 216 of the core network 130, the FEC encoding information via the SMF 214 of the core network 130.

Additionally, or alternatively, at 240 (e.g., a first operation of the signal flow operations 235) the application server 202 may provide the FEC encoding information to the AMF 212 (e.g., via the NEF 208 and the PCF 210). For example, the application server 202 may identify whether a traffic flow is FEC encoded, generate FEC encoding information for the data packets of the traffic flow accordingly, and may transmit the FEC encoding information to the NEF 208 (e.g., to check the FEC encoding information for malicious information). The NEF 208 may output the FEC encoding information to the PCF 210 to enforce one or more policies associated with the FEC encoding information, and the PCF may output the FEC encoding information to the AMF 212. At 245 (e.g., a second operation of the signal flow operations 235), the AMF 212 may output (e.g., transmit) the FEC encoding information to the network entity 105-a. That is, the network entity 105-a may receive, from the AMF 212 of the core network 130, the FEC encoding information via the NEF 208 of the core network 130, the PCF 210 of the core network 130, or both. Whether the signal flow operations 220, the signal flow operations 235, or both, occur, the FEC encoding information may indicate the same information.

At 250, the network entity 105-a may obtain the data packets associated with the FEC encoding information. In some examples, the application server 202 may transmit the data packets (e.g., which may be encoded according to the FEC encoding scheme, as indicated by the FEC encoding information) to the network entity 105-a. In some examples, the application server 202 may transmit the data packets to the NEF 208, which may output the data packets to the network entity 105-a (e.g., via one or more functions of the core network 130) after scanning for malicious information.

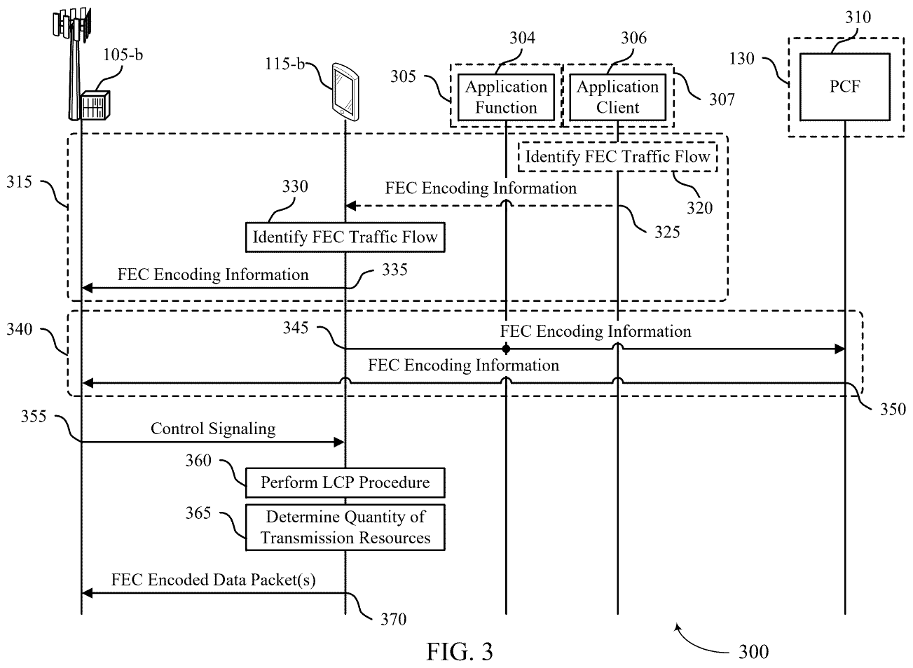

At 255, the network entity 105-a may transmit control signaling (e.g., one or more downlink control information (DCI) messages, one or more downlink scheduling grants) that schedules communication of the FEC encoded data packets associated with the traffic flow for the UE 115-a based on the FEC encoding information. For example, the control signaling may increase a radio resource diversity associated with the FEC encoded data packets by scheduling the FEC encoded data packets in diverse transmission resources. For example, the network entity 105-a may schedule the downlink transmission of the FEC encoded data packets in multiple carriers or cell groups (e.g., if the UE 115-a supports carrier aggregation, dual connectivity, or both), multiple TBs, multiple CBs or CBGs, or any combination thereof, which may be associated with diverse radio resource properties (e.g., as described with respect to the exemplary techniques of FIG. 3).

At 260, the network entity 105-a may communicate (e.g., transmit) the data packets (e.g., FEC encoded data packets) associated with the traffic flow with the UE 115-a based on the control signaling (e.g., the scheduled resources) and the FEC encoding information. For example, the network entity 105-a may transmit the data packets to the UE 115-a by spreading the transmission of the data packets across the diverse transmission resources scheduled by the control signaling. Accordingly, the UE 115-a may receive the FEC encoded data packets via diversified radio resources, resulting in FEC encoded signaling that is more robust against interference, noise, and other negative communication effects.

FIG. 3 shows an example of a process flow 300 that supports error correction-based scheduling for wireless communications in accordance with one or more aspects of the present disclosure. In some cases, aspects of the process flow 300 may implement or be implemented by aspects of FIGS. 1 and 2. For example, the process flow 300 may include a network entity 105-b (e.g., an example of the network entities 105 described with respect to FIGS. 1 and 2), a UE 115-b (e.g., an example of the UEs 115 as described with respect to FIGS. 1 and 2), and a PCF 310 of the core network 130 (e.g., an example of the PCF and PCF 210 described with respect to FIGS. 1 and 2). The process flow 200 may also include an application function 304 and an application client 306, which may be parts of a network device 305 and a network device 307, respectively (e.g., examples of network devices described with respect to FIG. 1, such as a server device). In some aspects, the process flow 300 may illustrate techniques for error correction-based scheduling for uplink communication, where the network entity 105-a may obtain the FEC encoding information for data packets associated with a traffic flow from one or more functions of the core network 130 or the UE 115-b, and the network entity 105-b may receive the data packets from the UE 115-a based on the FEC encoding information.

In the following description of process flow 300, the operations may be performed in a different order than the order shown, or other operations may be added or removed from the process flow 300. For example, some operations may be left out of process flow 300, may be performed in different orders or at different times, or other operations may be added to process flow 300. Although the UE 115-b, the network entity 105-b, the application function 304, the application client 306, and the PCF 310 are shown performing the operations of process flow 200, some aspects of some operations may also be performed by one or more other wireless devices or network devices (e.g., as described with respect to FIG. 1).

To increase the diversity and effectiveness of FEC encoded data packet communication in a wireless communications system, the network entity 105-a (e.g., the RAN) may obtain FEC encoding information associated with one or more data packets associated with a traffic flow of the UE 115-a. For example, the FEC encoding information may indicate to the network entity 105-a whether a traffic flow is encoded according to FEC to enable the network entity 105-a to provide more diverse radio resources for communicating the traffic flow. The FEC encoding information may also include other information, as described with respect to FIG. 2.

The process flow 200 illustrates the techniques of this disclosure in the context of uplink communication (e.g., the data packets associated with the traffic flow may be transmitted from the UE 115-a to the network entity 105-a). Thus, the network entity 105-b may obtain the FEC encoding information from the UE 115-b or from one or more functions of the core network 130. For example, signal flow operations 315 and signal flow operations 340 may be alternative or additional examples of obtaining the FEC encoding information at the network entity 105-b from the UE 115-b and from functions of the core network 130, respectively. Thus, one or more of the signal flow operations 315 and the signal flow operations 340 may occur for the network entity 105-a to obtain the FEC encoding information for data packets associated with a traffic flow of the UE 115-a.

For example, at 320 (e.g., a first operation of the signal flow operations 315), the application client 306 may identify a traffic flow (e.g., a QoS flow) where one or more packets within the traffic flow are encoded according to the FEC encoding scheme, and may accordingly generate FEC encoding information associated with the data packets (e.g., as described herein). At 325 (e.g., a second operation of the signal flow operations 315), the application client 306 may directly provide the FEC encoding information to the UE 115-b. That is, the UE 115-b may receive, from the application client 306, the FEC encoding information.

At, 330 (e.g., a third operation of the signal flow operations 315), the UE 115-a may identify whether the traffic flow is encoded according to the FEC encoding scheme, and may generate FEC encoding information for the traffic flow accordingly. For example, the UE 115-b itself may identify whether the traffic flow is FEC encoded (e.g., by directly observing one or more data packets of the traffic flow, without explicit indication from another entity), or the UE 115-b may identify whether the traffic flow is FEC encoded based on receiving the FEC encoding information from the application client at 325. In either case, at 335, the UE 115-b may transmit the FEC encoding information to the network entity 105-b. For example, the UE 115-b may transmit assistance information associated with the UE 115-b to a network entity 105-b, where the assistance information may include (e.g., in an information element, in a field) the FEC encoding information. In some cases (e.g., if the UE 115-b received the FEC encoding information from the application client 306), the assistance information may include the FEC encoding information received from the application client 306 (e.g., instead of FEC encoding information identified or determined by the UE 115-b itself).

Additionally, or alternatively, at 345 (e.g., a first operation of the signal flow operations 340) and after identifying whether the traffic flow is FEC encoded, the UE 115-b may transmit the FEC encoding information to the PCF 310 via the application function 304. For example, the UE 115-b may transmit the FEC encoding information to the application function 304, and the application function 304 may transmit the FEC encoding information to the PCF 310. At 350, the PCF may output (e.g., forward, transmit) the FEC information to the network entity 105-b. That is, the network entity 105-b may obtain (e.g., receive), from the PCF 310 of the core network 130, an indication of the FEC encoding information via the application function 304 associated with the data packets. Whether the signal flow operations 315, the signal flow operations 340, or both, occur, the FEC encoding information may indicate the same information (e.g., as described with respect to FIG. 2).

At 355, the UE 115-b may receive control signaling (e.g., one or more DCI message, one or more uplink scheduling grants) that schedules transmission of the FEC encoded data packets associated with the traffic flow to the network entity 105-b based at least in part on the FEC encoding information. For example, the control signaling may increase radio resource diversity associated with the FEC encoded data packets via one or more exemplary techniques (e.g., which may also be implemented in FIG. 2).

In one exemplary technique, the network entity 105-b may increase the radio resource diversity of the FEC encoded data packets by scheduling uplink communication of the FEC encoded data packets over multiple carriers, multiple cell groups, or both, based on the UE 115-a supporting carrier aggregation, dual connectivity, or both, and in response to the FEC encoding information. For example, different carriers or cell groups may have independent channel conditions and interference levels (e.g., due to a diversity in frequency resources), and thus transmitting the FEC encoded data packets via different carriers or cell groups may increase a radio resource diversity of the FEC encoded data packets. Thus, if the UE 115-a is configured with carrier aggregation or dual connectivity, the UE 115-a may be scheduled to communicate (e.g., transmit) the FEC encoded data packets (e.g., data packets in an FEC encoded traffic flow) over different carriers (e.g., in the case of carrier aggregation) or different cell groups (e.g., in case of dual connectivity) to leverage the diversity in frequency associated with the carriers or cell groups and increase the communication quality of the FEC encoded data packets.

In another exemplary technique, the network entity 105-b may increase a diversity of the FEC encoded data packets in the spatial domain by scheduling uplink communication of the data packets over multiple TBs in response to the FEC encoding information. For example, if the UE 115-a supports MIMO operations, the control signaling (e.g., a single uplink scheduling grant) may schedule multiple TBs for communication of the FEC encoded data packets, where each TB of the multiple TBs may be associated with a different respective MIMO communication layer of multiple MIMO communication layers. In some cases, the MIMO communication layers may be diverse (e.g., independent, separated, protected from interference) in the spatial domain. Additionally, or alternatively, TBs in different MIMO layers may not be correlated (e.g., or share radio resources). Thus, the network entity 105-a may schedule the UE 115-a to receive different FEC encoded data packets (e.g., data packets in an FEC encoded traffic flow) in different TBs to leverage the diversity of the TBs in the spatial domain.

In yet another exemplary technique, the network entity 105-a may increase a radio resource diversity of the FEC encoded data packets in a frequency domain by scheduling uplink communication of the FEC encoded data packets in resources that are divided into multiple CBs, which may be organized in (e.g., associated with) CBGs, in response to the FEC encoding information. The control signaling may schedule a single TB that includes the multiple CBs or CBGs (e.g., as in the case of carrier aggregation or dual connectivity), or may schedule multiple TBs that include the CBs or CBGs spread amongst the multiple TBs. The different CBs or CBGs may occupy different subcarriers, which may be associated with different channel gains and interference levels, increasing a radio resource diversity of the FEC encoded data packets communicated via different CBs. For example, a first CB of the CBs may be associated with a first subcarrier and a second CB of the CBs may be associated with a second subcarrier. Thus, the network entity 105-b may schedule transmission of FEC encoded data packets (e.g., data packets in an FEC encoded traffic flow) in different CBs or CBGs to leverage the diversity of the CBs or CBGs in the frequency domain.

Regardless of the techniques used to increase the radio resource diversity in the uplink scheduling of the FEC encoded data packets, the UE 115-b may, at 360, perform a logical channel prioritization (LCP) procedure on the transmission resources (e.g., physical uplink shared channel (PUSCH) resources) indicated by the control signaling at 355. For example, the LCP procedure may include determining a data rate provided to each logical channel indicated by the transmission resources, where higher priority higher priority logical channels (e.g., as set and indicated by the network entity 105-b) may be provided with enough resources for a corresponding data rate before providing a lower priority logical channel with any resource. A transmission resource, as used herein, may refer to a single TB scheduled on a carrier or in a cell group, a TB of multiple TBs scheduled by the control signaling at 355 (e.g., a TB of a multi-TB uplink grant), or a CB or CBG within a TB (e.g., such as the single TB or the TB of the multiple TBs), or any combination thereof. In some cases, the UE 115-b may perform the LCP procedure (e.g., a legacy LCP procedure) on all of the transmission resources indicated by the control signaling (e.g., instead of on individual transmission resources) to determine whether the FEC encoded data packets (e.g., from a logical channel associated with the traffic flow) are eligible to be transmitted in the transmission resources. Additionally, or alternatively, the LCP procedure may determine a quantity of the FEC encoded data packets that are eligible to be transmitted in the transmission resources, where the quantity may be denoted as Pₜₒₜₐₗ, and where Pₜₒₜₐₗ may be a non-integer.

At 365, the UE 115-b may determine a quantity of separate transmission resources available for diversified transmission of the FEC encoded data packets. In some cases, the determination may include multiplying a first quantity of TBs that are associated with different MIMO communication layers by a second quantity of CBs within each transport block. For example, if the control signaling (e.g., an uplink grant) schedules a first quantity of TBs (e.g., associated with different MIMO communication layers) for communication of the data packets, and each TB of the scheduled TBs includes a second quantity of CBs, then a total quantity of available transmission resources for the FEC traffic flow may be the first quantity multiplied by the second quantity.

At 370, the UE 115-b may transmit the FEC encoded data packets associated with the traffic flow to the network entity 105-b. For example, the UE 115-b may transmit the FEC encoded data packets based on the FEC encoding information, the resources scheduled by the control signaling, the quantity Pₜₒₜₐₗ, the quantity of transmission resources, or any combination thereof. For example, the UE 115-b may distribute transmission of the quantity of eligible data packets Pₜₒₜₐₗ among the total quantity of available PUSCH resources.

In one example (e.g., if the control signaling schedules the communication of the data packets over multiple carriers or cell groups), the UE 115-b may transmit different FEC encoded data packets (e.g., from the FEC encoded traffic flow) over different carriers or cell groups. For example, the UE 115-b may transmit a first packet of the FEC encoded data packets in a first carrier of multiple carriers or a first cell group of multiple cell groups (e.g., if the multiple carriers or cell groups are indicated by the control signaling) based on the FEC encoding information and may transmit a second packet of the FEC encoded data packets in a second carrier of the multiple carriers or a second cell group of the multiple cell groups based on the control signaling and the FEC encoding information.

In another example (e.g., if the control signaling schedules the communication of the data packets over multiple TBs), the UE 115-b may transmit different FEC encoded data packets in different TBs scheduled by the control signaling (e.g., a multi-TB-scheduling uplink grant). For example, the UE 115-b may transmit a first data packet of the FEC encoded data packets in a first TB of multiple TBs associated with a first MIMO communication layer (e.g., if the control signaling schedules multiple TBs) based on the FEC encoding information, and may transmit a second data packet of the FEC encoded data packets in a second TB of the multiple TBs associated with a second MIMO communication layer based on the control signaling and the FEC encoding information.

In yet another example (e.g., if the control signaling schedules the communication of the data packets over multiple CBs or CBGs), the UE 115-b may transmit different FEC encoded data packets in different CBs or CBGs. For example, the UE 115-b may transmit a first data packet of the FEC encoded data packets in a first CB of multiple CBs (e.g., if the control signaling indicates the multiple CBs) based on the FEC encoding information, and may transmit a second data packet of the FEC encoded data packets in a second CB of the multiple CBs based on the control signaling and the FEC encoding information.

In some cases, the UE 115-b may utilize one or more techniques to distribute the transmission of the FEC encoded data packets amongst the different transmission resources (e.g., groups of PUSCH resources, TBs, CBs, CBGs) scheduled by the control signaling. In one example, the UE 115-b may perform a hashing function, which may divide the Pₜₒₜₐₗ data packets (e.g., original non-encoded data packets) into K groups (e.g., where K is the quantity of FEC encoded data packets) of transmission resources. In some cases, the hashing function may be associated with sequence numbers of the original data packets or the FEC encoded data packets. For example, the hashing function may be based on a modulo operation on a sequence of each data packet of the data packets. Additionally, or alternatively, (e.g., if the UE 115-b supports carrier aggregation or dual connectivity), the modulo operation may also receive a carrier index for each data packet as a parameters.

In another example, the UE 115-b may randomly determine which transmission resource is used to transmit each data packet of the FEC encoded data packets. For example, the UE 115-b may utilize a probability of 1/K, where K is the quantity of FEC encoded data packets that carry the original data packets (e.g., the non-encoded data packets). For example, for a data packet (e.g., a PDU) among the Pₜₒₜₐₗ data packets, the UE 115-b (e.g., or the network entity 105-b) may randomly choose a transmission resource (e.g., with a probably of 1/K for each transmission resource) in which to transmit the data packet. The UE 115-b may repeat this random selection for each data packet until all Pₜₒₜₐₗ data packets are scheduled for transmission in the FEC encoded data packets, the transmission of which is spread amongst the transmission resources.

In some cases, the UE 115-b may repeat the process for distributing the transmission of the data packets amongst the transmission resources for one or more iterations. For example, after distributing one or more data packets to one or more transmission resources according to one of the examples described herein, a size of a remaining available portion (e.g., a remaining size) of a transmission resource j may be Tⱼ. In some cases, if the size Tj is less than a size of a data packet to include in (e.g., transmit via) the transmission resource j, the UE 115-b may break the data packet into segments. A size of a first RLC segment of the data packet may be equal to the size Tj, and the UE 115-b may multiplex the first segment into the transmission resource j (e.g., into the remaining available portion). Additionally, or alternatively, the UE 115-b may keep the remaining RLC segments of the data packet in a buffer of the UE 115-b to be transmitted in transmission resources indicated by subsequent control signaling (e.g., a later uplink grant). That is, the UE 115-b may transmit a first RLC segment of a data packet of the FEC encoded data packets in the remaining available portion of a transmission resource of the transmission resources indicated by the control signaling based on a first size of the first RLC segment being equal to the size Tⱼ of the remaining available portion, and may buffer one or more second RLC segments of the data packet for transmission in a second transmission resource indicated by second control signaling (e.g., not shown).

Accordingly, the UE 115-b may transmit FEC encoded data packets to the network entity 105-b using diversified radio resources. Such techniques may increase a robustness of the FEC encoded data packets against interference, noise, and other negative communication effects in a wireless communications system.

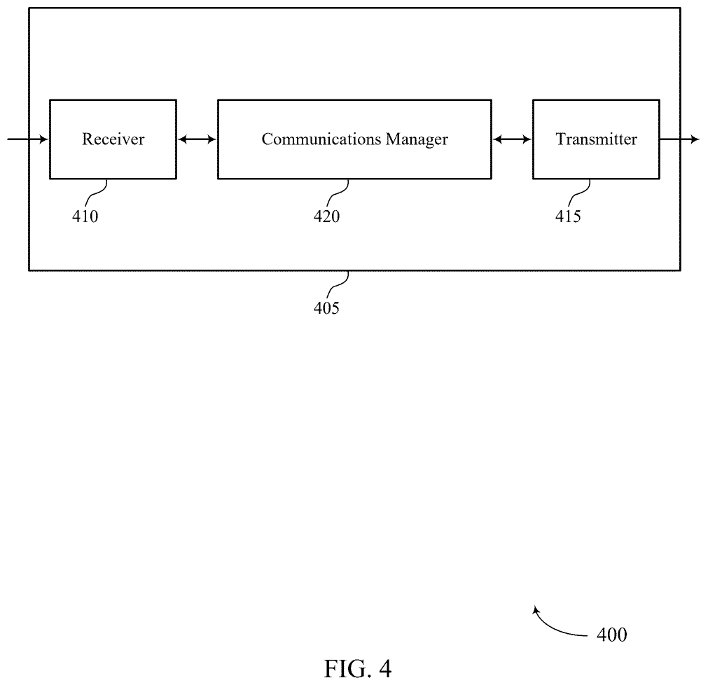

FIG. 4 shows a block diagram 400 of a device 405 that supports error correction-based scheduling for wireless communications in accordance with one or more aspects of the present disclosure. The device 405 may be an example of aspects of a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of error correction-based scheduling for wireless communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for obtaining forward error correction encoding information for data packets associated with a traffic flow of a UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The communications manager 420 is capable of, configured to, or operable to support a means for transmitting control signaling that schedules communication of the data packets associated with the traffic flow for the UE based on the forward error correction encoding information. The communications manager 420 is capable of, configured to, or operable to support a means for communicating the data packets associated with the traffic flow with the UE based on the control signaling and the forward error correction encoding information.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources. For example, a network entity 105 implementing the techniques described herein may communicate more FEC encoded data packets with less loss of packets due to higher diversity in the radio resources used to communicate the FEC encoded data packets. Thus, the network entity 105 may utilize less communication resources to retransmit FEC encoded data packets, increasing an efficiency for utilizing communication resources.

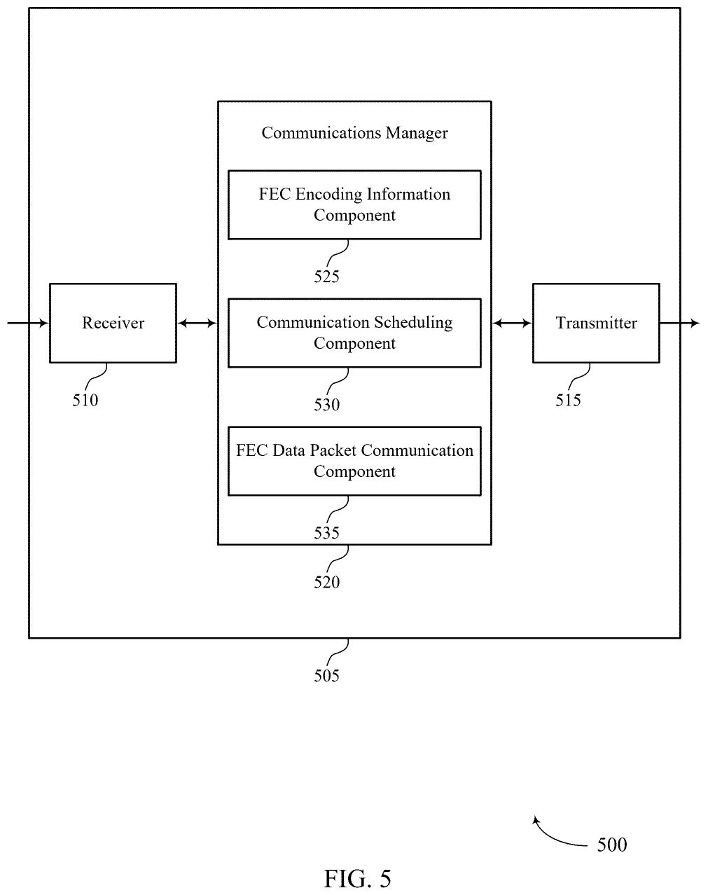

FIG. 5 shows a block diagram 500 of a device 505 that supports error correction-based scheduling for wireless communications in accordance with one or more aspects of the present disclosure. The device 505 may be an example of aspects of a device 405 or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of error correction-based scheduling for wireless communications as described herein. For example, the communications manager 520 may include a FEC encoding information component 525, a communication scheduling component 530, a FEC data packet communication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The FEC encoding information component 525 is capable of, configured to, or operable to support a means for obtaining forward error correction encoding information for data packets associated with a traffic flow of a UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The communication scheduling component 530 is capable of, configured to, or operable to support a means for transmitting control signaling that schedules communication of the data packets associated with the traffic flow for the UE based on the forward error correction encoding information. The FEC data packet communication component 535 is capable of, configured to, or operable to support a means for communicating the data packets associated with the traffic flow with the UE based on the control signaling and the forward error correction encoding information.

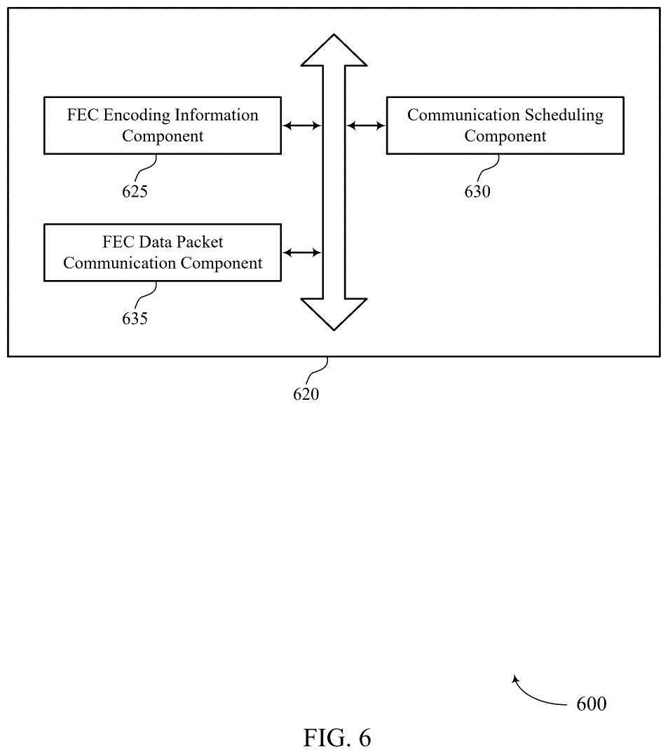

FIG. 6 shows a block diagram 600 of a communications manager 620 that supports error correction-based scheduling for wireless communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of error correction-based scheduling for wireless communications as described herein. For example, the communications manager 620 may include a FEC encoding information component 625, a communication scheduling component 630, a FEC data packet communication component 635, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communications in accordance with examples as disclosed herein. The FEC encoding information component 625 is capable of, configured to, or operable to support a means for obtaining forward error correction encoding information for data packets associated with a traffic flow of a UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The communication scheduling component 630 is capable of, configured to, or operable to support a means for transmitting control signaling that schedules communication of the data packets associated with the traffic flow for the UE based on the forward error correction encoding information. The FEC data packet communication component 635 is capable of, configured to, or operable to support a means for communicating the data packets associated with the traffic flow with the UE based on the control signaling and the forward error correction encoding information.

In some examples, to support obtaining the forward error correction encoding information, the FEC encoding information component 625 is capable of, configured to, or operable to support a means for receiving, from the UE, assistance information including the forward error correction encoding information.

In some examples, to support obtaining the forward error correction encoding information, the FEC encoding information component 625 is capable of, configured to, or operable to support a means for receiving, from a policy control function of a core network, an indication of the forward error correction encoding information via an application function associated with the data packets.

In some examples, to support obtaining the forward error correction encoding information, the FEC encoding information component 625 is capable of, configured to, or operable to support a means for receiving, from a user plane function of a core network, the forward error correction encoding information via a session management function of the core network.

In some examples, to support obtaining the forward error correction encoding information, the FEC encoding information component 625 is capable of, configured to, or operable to support a means for receiving, from an access and mobility management function of a core network, the forward error correction encoding information via a network exposure function of the core network, a policy control function of the core network, or both.

In some examples, the control signaling that schedules the communication of the data packets associated with the traffic flow indicates a set of multiple carriers, a set of multiple cell groups, or a combination thereof, based on the forward error correction encoding information.

In some examples, to support communicating the data packets associated with the traffic flow, the FEC data packet communication component 635 is capable of, configured to, or operable to support a means for receiving a first packet of the data packets in a first carrier of the set of multiple carriers or a first cell group of the set of multiple cell groups based on the control signaling and the forward error correction encoding information. In some examples, to support communicating the data packets associated with the traffic flow, the FEC data packet communication component 635 is capable of, configured to, or operable to support a means for receiving a second packet of the data packets in a second carrier of the set of multiple carriers or a second cell group of the set of multiple cell groups based on the control signaling and the forward error correction encoding information.

In some examples, the control signaling that schedules the communication of the data packets associated with the traffic flow indicates a set of multiple transport blocks that are each associated with a respective MIMO communication layer based on the forward error correction encoding information and a capability of the UE to support MIMO operations.

In some examples, to support communicating the data packets associated with the traffic flow, the FEC data packet communication component 635 is capable of, configured to, or operable to support a means for receiving a first data packet of the data packets in a first transport block of the set of multiple transport blocks associated with a first MIMO communication layer based on the control signaling and the forward error correction encoding information. In some examples, to support communicating the data packets associated with the traffic flow, the FEC data packet communication component 635 is capable of, configured to, or operable to support a means for receiving a second data packet of the data packets in a second transport block of the set of multiple transport blocks associated with a second MIMO communication layer based on the control signaling and the forward error correction encoding information.

In some examples, the control signaling that schedules the communication of the data packets associated with the traffic flow indicates a set of multiple code blocks associated with one or more code block groups based on the forward error correction encoding information. In some examples, a first code block of the set of multiple code blocks is associated with a first subcarrier and a second code block of the set of multiple code blocks is associated with a second subcarrier.

In some examples, to support communicating the data packets associated with the traffic flow, the FEC data packet communication component 635 is capable of, configured to, or operable to support a means for receiving a first data packet of the data packets in the first code block based on the control signaling and the forward error correction encoding information. In some examples, to support communicating the data packets associated with the traffic flow, the FEC data packet communication component 635 is capable of, configured to, or operable to support a means for receiving a second data packet of the data packets in the second code block based on the control signaling and the forward error correction encoding information.

In some examples, the set of multiple code blocks are associated with one or more transport blocks indicated by the control signaling.

In some examples, the one or more encoding parameters of the data packets associated with the traffic flow indicates a ratio of a first quantity of the data packets to a second quantity of forward error correction encoded packets used to communicate the data packets. In some examples, the second quantity is larger than the first quantity.

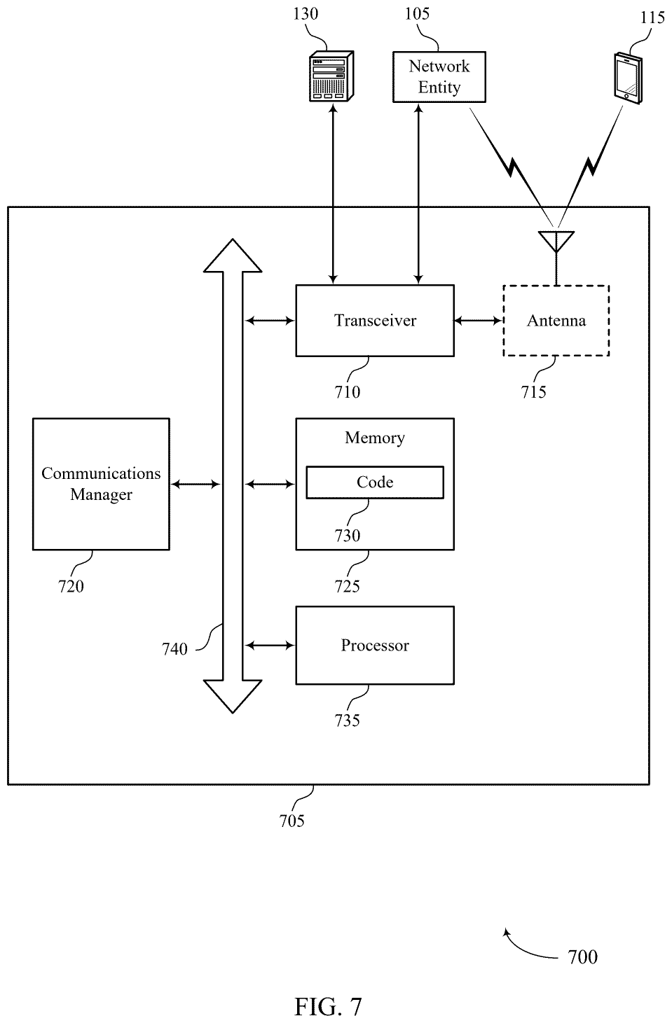

FIG. 7 shows a diagram of a system 700 including a device 705 that supports error correction-based scheduling for wireless communications in accordance with one or more aspects of the present disclosure. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting error correction-based scheduling for wireless communications). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communications in accordance with examples as disclosed herein. For example, the communications manager 720 is capable of, configured to, or operable to support a means for obtaining forward error correction encoding information for data packets associated with a traffic flow of a UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The communications manager 720 is capable of, configured to, or operable to support a means for transmitting control signaling that schedules communication of the data packets associated with the traffic flow for the UE based on the forward error correction encoding information. The communications manager 720 is capable of, configured to, or operable to support a means for communicating the data packets associated with the traffic flow with the UE based on the control signaling and the forward error correction encoding information.

By including or configuring the communications manager 720 in accordance with examples as described herein, the device 705 may support techniques for improved communication reliability and reduced latency. For example, a network entity 105 implementing the techniques described herein may encounter less errors or failures while communicating FEC encoded data packets due to increased diversity in radio resources used to communicate the FEC encoded data packets. This reduction in errors and failures may increase a communication reliability and reduce a latency associated with the network entity 105.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of error correction-based scheduling for wireless communications as described herein, or the at least one processor 735 and the at least one memory 725 may be otherwise configured to, individually or collectively, perform or support such operations.

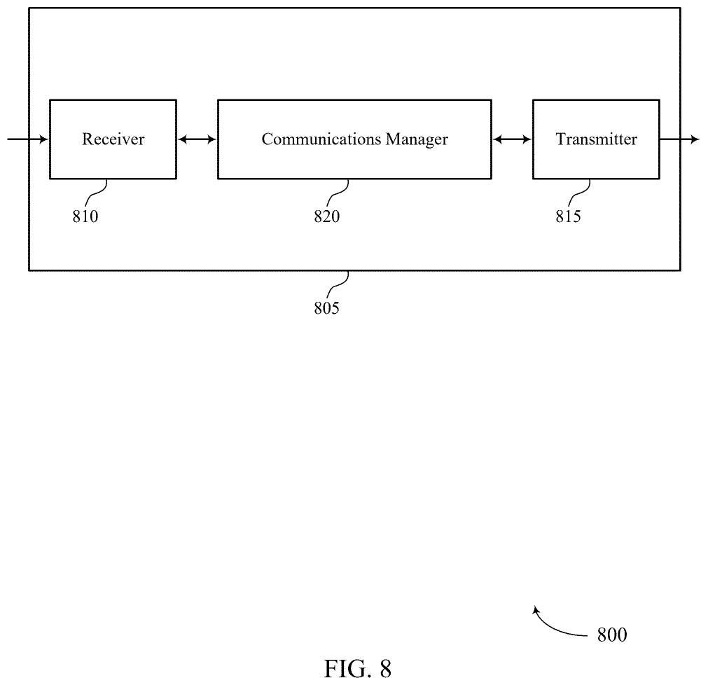

FIG. 8 shows a block diagram 800 of a device 805 that supports error correction-based scheduling for wireless communications in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to error correction-based scheduling for wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to error correction-based scheduling for wireless communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of error correction-based scheduling for wireless communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting forward error correction encoding information for data packets associated with a traffic flow of the UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The communications manager 820 is capable of, configured to, or operable to support a means for receiving control signaling that schedules transmission of the data packets associated with the traffic flow to a network entity based on the forward error correction encoding information. The communications manager 820 is capable of, configured to, or operable to support a means for transmitting the data packets associated with the traffic flow to the network entity based on the control signaling and the forward error correction encoding information.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources. For example, a UE 115 implementing the techniques described herein may communicate more FEC encoded data packets with less loss of packets due to higher diversity in the radio resources used to communicate the FEC encoded data packets. Thus, the UE 115 may utilize less communication resources to retransmit FEC encoded data packets, increasing an efficiency for utilizing communication resources.

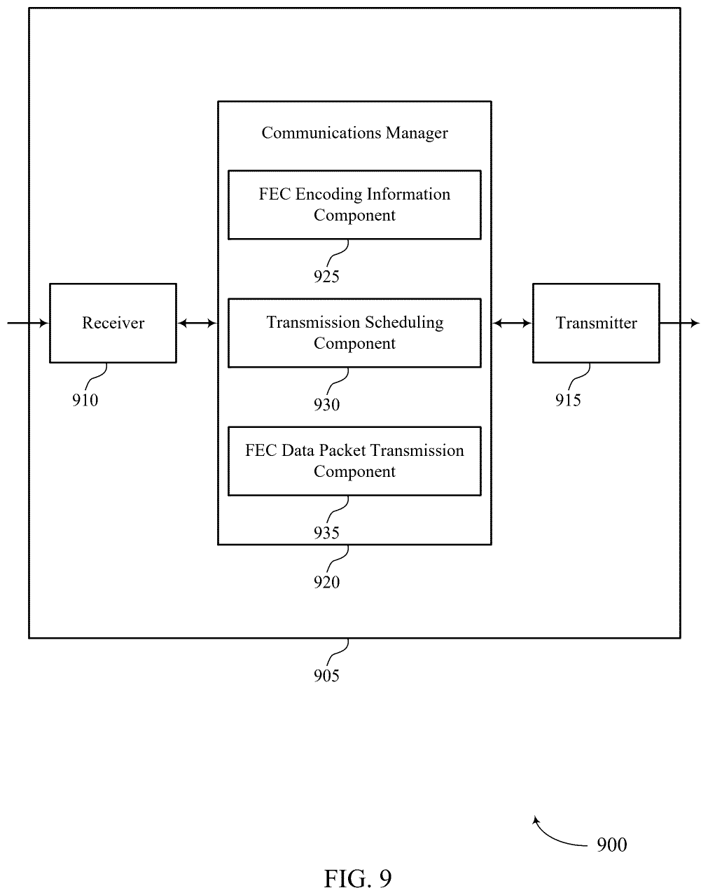

FIG. 9 shows a block diagram 900 of a device 905 that supports error correction-based scheduling for wireless communications in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to error correction-based scheduling for wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to error correction-based scheduling for wireless communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of error correction-based scheduling for wireless communications as described herein. For example, the communications manager 920 may include a FEC encoding information component 925, a transmission scheduling component 930, a FEC data packet transmission component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The FEC encoding information component 925 is capable of, configured to, or operable to support a means for transmitting forward error correction encoding information for data packets associated with a traffic flow of the UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The transmission scheduling component 930 is capable of, configured to, or operable to support a means for receiving control signaling that schedules transmission of the data packets associated with the traffic flow to a network entity based on the forward error correction encoding information. The FEC data packet transmission component 935 is capable of, configured to, or operable to support a means for transmitting the data packets associated with the traffic flow to the network entity based on the control signaling and the forward error correction encoding information.

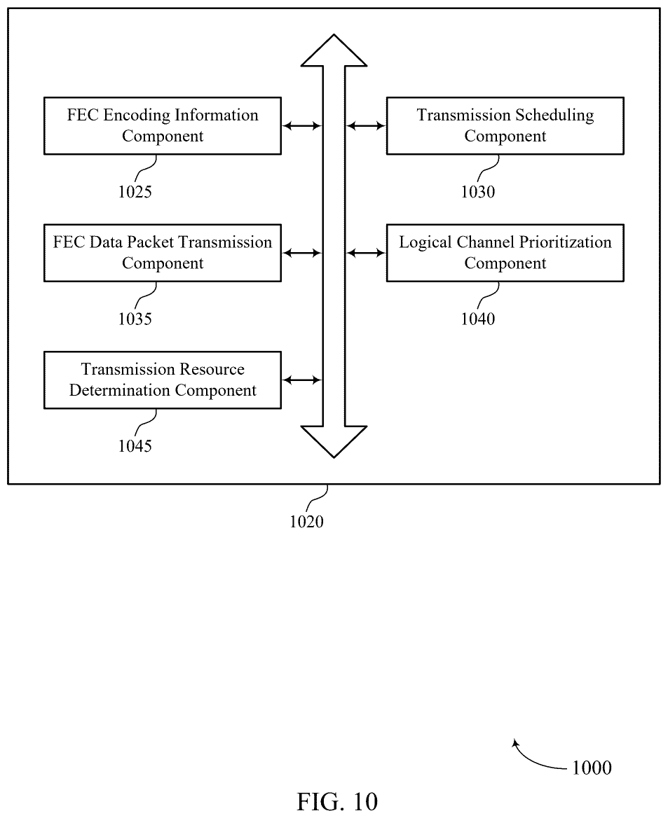

FIG. 10 shows a block diagram 1000 of a communications manager 1020 that supports error correction-based scheduling for wireless communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of error correction-based scheduling for wireless communications as described herein. For example, the communications manager 1020 may include a FEC encoding information component 1025, a transmission scheduling component 1030, a FEC data packet transmission component 1035, a logical channel prioritization component 1040, a transmission resource determination component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The FEC encoding information component 1025 is capable of, configured to, or operable to support a means for transmitting forward error correction encoding information for data packets associated with a traffic flow of the UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The transmission scheduling component 1030 is capable of, configured to, or operable to support a means for receiving control signaling that schedules transmission of the data packets associated with the traffic flow to a network entity based on the forward error correction encoding information. The FEC data packet transmission component 1035 is capable of, configured to, or operable to support a means for transmitting the data packets associated with the traffic flow to the network entity based on the control signaling and the forward error correction encoding information.

In some examples, to support transmitting the forward error correction encoding information, the FEC encoding information component 1025 is capable of, configured to, or operable to support a means for transmitting assistance information associated with the UE to a network entity, where the assistance information includes the forward error correction encoding information.

In some examples, the FEC encoding information component 1025 is capable of, configured to, or operable to support a means for receiving, from an application client, the forward error correction encoding information, where the assistance information includes the forward error correction encoding information received from the application client.

In some examples, the forward error correction encoding information is transmitted via an application function associated with the data packets to a policy control function of a core network.

In some examples, the control signaling that schedules the transmission of the data packets associated with the traffic flow indicates a set of multiple carriers, a set of multiple cell groups, or a combination thereof, based on the forward error correction encoding information.

In some examples, to support transmitting the data packets associated with the traffic flow, the FEC data packet transmission component 1035 is capable of, configured to, or operable to support a means for transmitting a first packet of the data packets in a first carrier of the set of multiple carriers or a first cell group of the set of multiple cell groups based on the control signaling and the forward error correction encoding information. In some examples, to support transmitting the data packets associated with the traffic flow, the FEC data packet transmission component 1035 is capable of, configured to, or operable to support a means for transmitting a second packet of the data packets in a second carrier of the set of multiple carriers or a second cell group of the set of multiple cell groups based on the control signaling and the forward error correction encoding information.

In some examples, the control signaling that schedules the transmission of the data packets associated with the traffic flow indicates a set of multiple transport blocks that are each associated with a respective MIMO communication layer based on the forward error correction encoding information and a capability of the UE to support MIMO operations.

In some examples, to support transmitting the data packets associated with the traffic flow, the FEC data packet transmission component 1035 is capable of, configured to, or operable to support a means for transmitting a first data packet of the data packets in a first transport block of the set of multiple transport blocks associated with a first MIMO communication layer based on the control signaling and the forward error correction encoding information. In some examples, to support transmitting the data packets associated with the traffic flow, the FEC data packet transmission component 1035 is capable of, configured to, or operable to support a means for transmitting a second data packet of the data packets in a second transport block of the set of multiple transport blocks associated with a second MIMO communication layer based on the control signaling and the forward error correction encoding information.

In some examples, the control signaling that schedules the transmission of the data packets associated with the traffic flow indicates a set of multiple code blocks associated with one or more code block groups based on the forward error correction encoding information. In some examples, a first code block of the set of multiple code blocks is associated with a first subcarrier and a second code block of the set of multiple code blocks is associated with a second subcarrier.

In some examples, to support transmitting the data packets associated with the traffic flow, the FEC data packet transmission component 1035 is capable of, configured to, or operable to support a means for transmitting a first data packet of the data packets in the first code block based on the control signaling and the forward error correction encoding information. In some examples, to support transmitting the data packets associated with the traffic flow, the FEC data packet transmission component 1035 is capable of, configured to, or operable to support a means for transmitting a second data packet of the data packets in the second code block based on the control signaling and the forward error correction encoding information.

In some examples, the set of multiple code blocks are associated with one or more transport blocks indicated by the control signaling.

In some examples, the one or more encoding parameters of the data packets associated with the traffic flow is a ratio of a first quantity of data packets to a second quantity of forward error correction encoded packets used to communicate the data packets. In some examples, the second quantity is larger than the first quantity.

In some examples, the logical channel prioritization component 1040 is capable of, configured to, or operable to support a means for performing a logical channel prioritization procedure on transmission resources indicated by the control signaling to determine whether the data packets encoded according to the forward error correction encoding scheme are eligible to be transmitted via the transmission resources, where the data packets are transmitted based on the logical channel prioritization procedure.

In some examples, the transmission resource determination component 1045 is capable of, configured to, or operable to support a means for determining a quantity of transmission resources indicated by the control signaling for transmission of the data packets, where a transmission resource of the transmission resources may be a transport block scheduled in a carrier or in a cell group, a transport block associated with a respective multiple-input multiple-output (MIMO) communication layer, a code block or code block group within a transport block, or any combination thereof, where the data packets are transmitted based on the quantity of the transmission resources.

In some examples, to support determining the quantity of the transmission resources indicated by the control signaling, the transmission resource determination component 1045 is capable of, configured to, or operable to support a means for multiplying a first quantity of transport blocks that are associated with different MIMO communication layers by a second quantity of code blocks within each transport block.

In some examples, to support transmitting the data packets associated with the traffic flow, the FEC data packet transmission component 1035 is capable of, configured to, or operable to support a means for transmitting the data packets associated with the traffic flow amongst the transmission resources based on a hashing function associated with sequence numbers of the data packets.

In some examples, the hashing function is based on a modulo operation performed on the sequence numbers of the data packets.

In some examples, the modulo operation receives one or more carrier indices as inputs based on a set of multiple carriers, a set of multiple cell groups, or both, indicated by the control signaling.

In some examples, to support transmitting the data packets associated with the traffic flow, the FEC data packet transmission component 1035 is capable of, configured to, or operable to support a means for transmitting the data packets associated with the traffic flow amongst the quantity of the transmission resources based on a common probability factor that each data packet of the data packets will be transmitted within a transmission resource of the transmission resources, where the common probability factor is an inverse of a quantity of forward error correction encoded packets that carries the data packets.

In some examples, to support transmitting the data packets associated with the traffic flow, the FEC data packet transmission component 1035 is capable of, configured to, or operable to support a means for transmitting a first RLC segment of a data packet of the data packets in a remaining available portion of a transmission resource of the transmission resources based on a first size of the first RLC segment being equal to a second size of the remaining available portion. In some examples, to support transmitting the data packets associated with the traffic flow, the FEC data packet transmission component 1035 is capable of, configured to, or operable to support a means for buffering one or more second RLC segments of the data packet for transmission in a second transmission resource indicated by second control signaling.

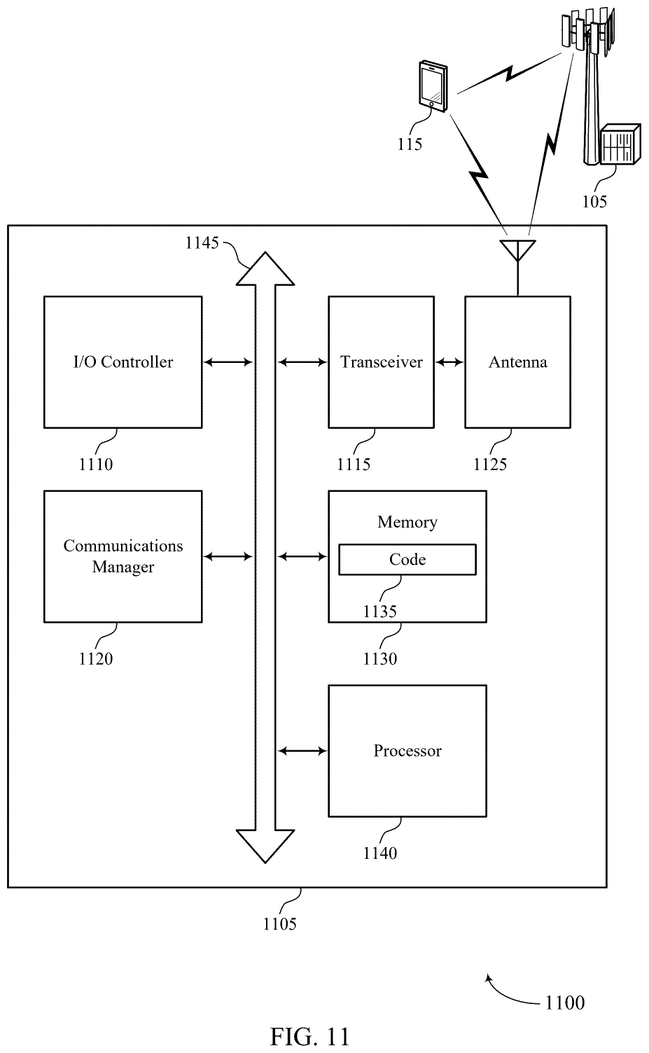

FIG. 11 shows a diagram of a system 1100 including a device 1105 that supports error correction-based scheduling for wireless communications in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting error correction-based scheduling for wireless communications). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting forward error correction encoding information for data packets associated with a traffic flow of the UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The communications manager 1120 is capable of, configured to, or operable to support a means for receiving control signaling that schedules transmission of the data packets associated with the traffic flow to a network entity based on the forward error correction encoding information. The communications manager 1120 is capable of, configured to, or operable to support a means for transmitting the data packets associated with the traffic flow to the network entity based on the control signaling and the forward error correction encoding information.

By including or configuring the communications manager 1120 in accordance with examples as described herein, the device 1105 may support techniques for improved communication reliability and reduced latency. For example, a UE 115 implementing the techniques described herein may encounter less errors or failures while communicating FEC encoded data packets due to increased diversity in radio resources used to communicate the FEC encoded data packets. This reduction in errors and failures may increase a communication reliability and reduce a latency associated with the UE 115.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of error correction-based scheduling for wireless communications as described herein, or the at least one processor 1140 and the at least one memory 1130 may be otherwise configured to, individually or collectively, perform or support such operations.

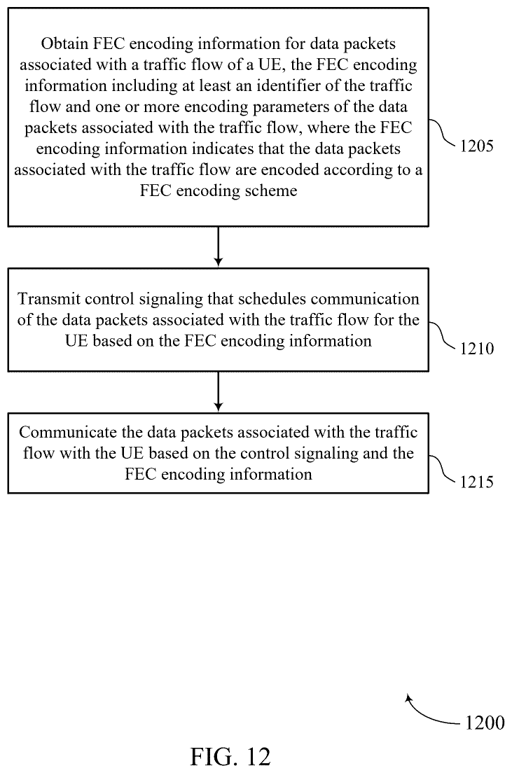

FIG. 12 shows a flowchart illustrating a method 1200 that supports error correction-based scheduling for wireless communications in accordance with one or more aspects of the present disclosure. The operations of the method 1200 may be implemented by a network entity or its components as described herein. For example, the operations of the method 1200 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1205, the method may include obtaining forward error correction encoding information for data packets associated with a traffic flow of a UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The operations of 1205 may be performed in accordance with examples as disclosed herein. In some examples, aspects of the operations of 1205 may be performed by a FEC encoding information component 625 as described with reference to FIG. 6.

At 1210, the method may include transmitting control signaling that schedules communication of the data packets associated with the traffic flow for the UE based on the forward error correction encoding information. The operations of 1210 may be performed in accordance with examples as disclosed herein. In some examples, aspects of the operations of 1210 may be performed by a communication scheduling component 630 as described with reference to FIG. 6.

At 1215, the method may include communicating the data packets associated with the traffic flow with the UE based on the control signaling and the forward error correction encoding information. The operations of 1215 may be performed in accordance with examples as disclosed herein. In some examples, aspects of the operations of 1215 may be performed by a FEC data packet communication component 635 as described with reference to FIG. 6.

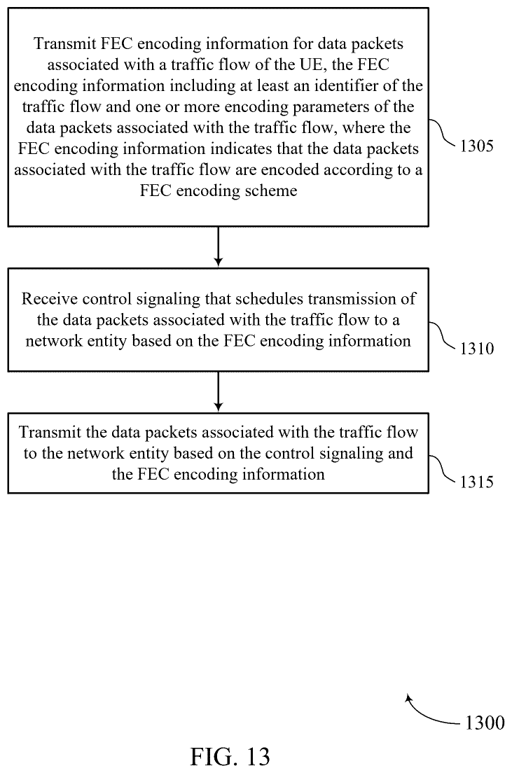

FIG. 13 shows a flowchart illustrating a method 1300 that supports error correction-based scheduling for wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 3 and 8 through 11. In some examples, a UE may execute a set of instructions to control the functional elements of the UE to perform the described functions. Additionally, or alternatively, the UE may perform aspects of the described functions using special-purpose hardware.

At 1305, the method may include transmitting forward error correction encoding information for data packets associated with a traffic flow of the UE, the forward error correction encoding information including at least an identifier of the traffic flow and one or more encoding parameters of the data packets associated with the traffic flow, where the forward error correction encoding information indicates that the data packets associated with the traffic flow are encoded according to a forward error correction encoding scheme. The operations of 1305 may be performed in accordance with examples as disclosed herein. In some examples, aspects of the operations of 1305 may be performed by a FEC encoding information component 1025 as described with reference to FIG. 10.

At 1310, the method may include receiving control signaling that schedules transmission of the data packets associated with the traffic flow to a network entity based on the forward error correction encoding information. The operations of 1310 may be performed in accordance with examples as disclosed herein. In some examples, aspects of the operations of 1310 may be performed by a transmission scheduling component 1030 as described with reference to FIG. 10.

At 1315, the method may include transmitting the data packets associated with the traffic flow to the network entity based on the control signaling and the forward error correction encoding information. The operations of 1315 may be performed in accordance with examples as disclosed herein. In some examples, aspects of the operations of 1315 may be performed by a FEC data packet transmission component 1035 as described with reference to FIG. 10.

The following provides an overview of aspects of the present disclosure:
Aspect 1: A method for wireless communications at a network entity, comprising: obtaining FEC encoding information for data packets associated with a traffic flow of a UE, the FEC encoding information comprising at least an identifier of the traffic flow and one or more encoding parameters of the data packets associated with the traffic flow, wherein the FEC encoding information indicates that the data packets associated with the traffic flow are encoded according to a FEC encoding scheme; transmitting control signaling that schedules communication of the data packets associated with the traffic flow for the UE based at least in part on the FEC encoding information; and communicating the data packets associated with the traffic flow with the UE based at least in part on the control signaling and the FEC encoding information.
Aspect 2: The method of aspect 1, wherein obtaining the FEC encoding information comprises: receiving, from the UE, assistance information comprising the FEC encoding information.
Aspect 3: The method of any of aspects 1 through 2, wherein obtaining the FEC encoding information comprises: receiving, from a PCF of a core network, an indication of the FEC encoding information via an application function associated with the data packets.
Aspect 4: The method of aspect 1, wherein obtaining the FEC encoding information comprises: receiving, from a UPF of a core network, the FEC encoding information via a SMF of the core network.
Aspect 5: The method of any of aspects 1 and 4, wherein obtaining the FEC encoding information comprises: receiving, from an AMF of a core network, the FEC encoding information via a NEF of the core network, a PCF of the core network, or both.
Aspect 6: The method of any of aspects 1 through 5, wherein the control signaling that schedules the communication of the data packets associated with the traffic flow indicates a plurality of carriers, a plurality of cell groups, or a combination thereof, based at least in part on the FEC encoding information.
Aspect 7: The method of aspect 6, wherein communicating the data packets associated with the traffic flow comprises: receiving a first packet of the data packets in a first carrier of the plurality of carriers or a first cell group of the plurality of cell groups based at least in part on the control signaling and the FEC encoding information; and receiving a second packet of the data packets in a second carrier of the plurality of carriers or a second cell group of the plurality of cell groups based at least in part on the control signaling and the FEC encoding information.
Aspect 8: The method of any of aspects 1 through 7, wherein the control signaling that schedules the communication of the data packets associated with the traffic flow indicates a plurality of transport blocks that are each associated with a respective MIMO communication layer based at least in part on the FEC encoding information and a capability of the UE to support MIMO operations.
Aspect 9: The method of aspect 8, wherein communicating the data packets associated with the traffic flow comprises: receiving a first data packet of the data packets in a first transport block of the plurality of transport blocks associated with a first MIMO communication layer based at least in part on the control signaling and the FEC encoding information; and receiving a second data packet of the data packets in a second transport block of the plurality of transport blocks associated with a second MIMO communication layer based at least in part on the control signaling and the FEC encoding information.
Aspect 10: The method of any of aspects 1 through 9, wherein the control signaling that schedules the communication of the data packets associated with the traffic flow indicates a plurality of code blocks associated with one or more code block groups based at least in part on the FEC encoding information, a first code block of the plurality of code blocks is associated with a first subcarrier and a second code block of the plurality of code blocks is associated with a second subcarrier.
Aspect 11: The method of aspect 10, wherein communicating the data packets associated with the traffic flow comprises: receiving a first data packet of the data packets in the first code block based at least in part on the control signaling and the FEC encoding information; and receiving a second data packet of the data packets in the second code block based at least in part on the control signaling and the FEC encoding information.
Aspect 12: The method of any of aspects 10 through 11, wherein the plurality of code blocks are associated with one or more transport blocks indicated by the control signaling.
Aspect 13: The method of any of aspects 1 through 12, wherein the one or more encoding parameters of the data packets associated with the traffic flow indicates a ratio of a first quantity of the data packets to a second quantity of FEC encoded packets used to communicate the data packets, the second quantity is larger than the first quantity.
Aspect 14: A method for wireless communications at a UE, comprising: transmitting FEC encoding information for data packets associated with a traffic flow of the UE, the FEC encoding information comprising at least an identifier of the traffic flow and one or more encoding parameters of the data packets associated with the traffic flow, wherein the FEC encoding information indicates that the data packets associated with the traffic flow are encoded according to a FEC encoding scheme; receiving control signaling that schedules transmission of the data packets associated with the traffic flow to a network entity based at least in part on the FEC encoding information; and transmitting the data packets associated with the traffic flow to the network entity based at least in part on the control signaling and the FEC encoding information.
Aspect 15: The method of aspect 14, wherein transmitting the FEC encoding information comprises: transmitting assistance information associated with the UE to a network entity, wherein the assistance information includes the FEC encoding information.
Aspect 16: The method of aspect 15, further comprising: receiving, from an application client, the FEC encoding information, wherein the assistance information includes the FEC encoding information received from the application client.
Aspect 17: The method of any of aspects 14 through 16, wherein the FEC encoding information is transmitted via an application function associated with the data packets to a policy control function of a core network.
Aspect 18: The method of any of aspects 14 through 17, wherein the control signaling that schedules the transmission of the data packets associated with the traffic flow indicates a plurality of carriers, a plurality of cell groups, or a combination thereof, based at least in part on the FEC encoding information.
Aspect 19: The method of aspect 18, wherein transmitting the data packets associated with the traffic flow comprises: transmitting a first packet of the data packets in a first carrier of the plurality of carriers or a first cell group of the plurality of cell groups based at least in part on the control signaling and the FEC encoding information; and transmitting a second packet of the data packets in a second carrier of the plurality of carriers or a second cell group of the plurality of cell groups based at least in part on the control signaling and the FEC encoding information.
Aspect 20: The method of any of aspects 14 through 19, wherein the control signaling that schedules the transmission of the data packets associated with the traffic flow indicates a plurality of transport blocks that are each associated with a respective MIMO communication layer based at least in part on the FEC encoding information and a capability of the UE to support MIMO operations.
Aspect 21: The method of aspect 20, wherein transmitting the data packets associated with the traffic flow comprises: transmitting a first data packet of the data packets in a first transport block of the plurality of transport blocks associated with a first MIMO communication layer based at least in part on the control signaling and the FEC encoding information; and transmitting a second data packet of the data packets in a second transport block of the plurality of transport blocks associated with a second MIMO communication layer based at least in part on the control signaling and the FEC encoding information.
Aspect 22: The method of any of aspects 14 through 21, wherein the control signaling that schedules the transmission of the data packets associated with the traffic flow indicates a plurality of code blocks associated with one or more code block groups based at least in part on the FEC encoding information, a first code block of the plurality of code blocks is associated with a first subcarrier and a second code block of the plurality of code blocks is associated with a second subcarrier.
Aspect 23: The method of aspect 22, wherein transmitting the data packets associated with the traffic flow comprises: transmitting a first data packet of the data packets in the first code block based at least in part on the control signaling and the FEC encoding information; and transmitting a second data packet of the data packets in the second code block based at least in part on the control signaling and the FEC encoding information.
Aspect 24: The method of any of aspects 22 through 23, wherein the plurality of code blocks are associated with one or more transport blocks indicated by the control signaling.
Aspect 25: The method of any of aspects 14 through 24, wherein the one or more encoding parameters of the data packets associated with the traffic flow is a ratio of a first quantity of data packets to a second quantity of FEC encoded packets used to communicate the data packets, the second quantity is larger than the first quantity.
Aspect 26: The method of any of aspects 14 through 25, further comprising: performing a logical channel prioritization procedure on transmission resources indicated by the control signaling to determine whether the data packets encoded according to the FEC encoding scheme are eligible to be transmitted via the transmission resources, wherein the data packets are transmitted based at least in part on the logical channel prioritization procedure.
Aspect 27: The method of any of aspects 14 through 26, further comprising: determining a quantity of transmission resources indicated by the control signaling for transmission of the data packets, wherein a transmission resource of the transmission resources may be a transport block scheduled in a carrier or in a cell group, a transport block associated with a respective MIMO communication layer, a code block or code block group within a transport block, or any combination thereof, wherein the data packets are transmitted based at least in part on the quantity of the transmission resources.
Aspect 28: The method of aspect 27, wherein determining the quantity of the transmission resources indicated by the control signaling comprises: multiplying a first quantity of transport blocks that are associated with different MIMO communication layers by a second quantity of code blocks within each transport block.
Aspect 29: The method of any of aspects 27 through 28, wherein transmitting the data packets associated with the traffic flow comprises: transmitting the data packets associated with the traffic flow amongst the transmission resources based at least in part on a hashing function associated with sequence numbers of the data packets.
Aspect 30: The method of aspect 29, wherein the hashing function is based at least in part on a modulo operation performed on the sequence numbers of the data packets.
Aspect 31: The method of aspect 30, wherein the modulo operation receives one or more carrier indices as inputs based at least in part on a plurality of carriers, a plurality of cell groups, or both, indicated by the control signaling.
Aspect 32: The method of any of aspects 27 and 28, wherein transmitting the data packets associated with the traffic flow comprises: transmitting the data packets associated with the traffic flow amongst the quantity of the transmission resources based at least in part on a common probability factor that each data packet of the data packets will be transmitted within a transmission resource of the transmission resources, wherein the common probability factor is an inverse of a quantity of FEC encoded packets that carries the data packets.
Aspect 33: The method of any of aspects 27 through 32, wherein transmitting the data packets associated with the traffic flow comprises: transmitting a first RLC segment of a data packet of the data packets in a remaining available portion of a transmission resource of the transmission resources based at least in part on a first size of the first RLC segment being equal to a second size of the remaining available portion; and buffering one or more second RLC segments of the data packet for transmission in a second transmission resources indicated by second control information.
Aspect 34: A network entity for wireless communications, comprising one or more memories storing processor-executable code, and one or more processors coupled with the one or more memories and individually or collectively operable to execute the code to cause the network entity to perform a method of any of aspects 1 through 13.
Aspect 35: A network entity for wireless communications, comprising at least one means for performing a method of any of aspects 1 through 13.
Aspect 36: A non-transitory computer-readable medium storing code for wireless communications, the code comprising instructions executable by one or more processors to perform a method of any of aspects 1 through 13.
Aspect 37: A UE for wireless communications, comprising one or more memories storing processor-executable code, and one or more processors coupled with the one or more memories and individually or collectively operable to execute the code to cause the UE to perform a method of any of aspects 14 through 33.
Aspect 38: A UE for wireless communications, comprising at least one means for performing a method of any of aspects 14 through 33.
Aspect 39: A non-transitory computer-readable medium storing code for wireless communications, the code comprising instructions executable by one or more processors to perform a method of any of aspects 14 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit forward error correction encoding information for data packets associated with a traffic flow of the UE, wherein the forward error correction encoding information indicates that the data packets associated with the traffic flow are encoded according to a forward error correction encoding scheme;
receive control signaling that schedules transmission of the data packets associated with the traffic flow to a network entity based at least in part on the forward error correction encoding information; and
transmit the data packets associated with the traffic flow to the network entity based at least in part on a quantity of transmission resources indicated by the control signaling for transmission of the data packets and the forward error correction encoding information.

2. The UE of claim 1, wherein the one or more processors are individually or collectively further operable to execute the code to cause the UE to:
perform a logical channel prioritization procedure on the transmission resources indicated by the control signaling to determine whether the data packets encoded according to the forward error correction encoding scheme are eligible to be transmitted via the transmission resources, wherein the data packets are transmitted based at least in part on the logical channel prioritization procedure.

3. The UE of claim 1, wherein a transmission resource of the transmission resources may be a transport block scheduled in a carrier or in a cell group, a transport block associated with a respective multiple-input multiple-output (MIMO) communication layer, a code block or code block group within a transport block, or any combination thereof.

4. The UE of claim 1, wherein the one or more processors are individually or collectively further operable to execute the code to cause the UE to:
multiply a first quantity of transport blocks that are associated with different multiple-input multiple-output (MIMO) communication layers by a second quantity of code blocks within each transport block to determine the quantity of the transmission resources indicated by the control signaling.

5. The UE of claim 1, wherein, to transmit the forward error correction encoding information, the one or more processors are individually or collectively operable to execute the code to cause the UE to:
transmit assistance information associated with the UE to the network entity, wherein the assistance information includes the forward error correction encoding information.

6. The UE of claim 5, wherein the one or more processors are individually or collectively further operable to execute the code to cause the UE to:
receive, from an application client, the forward error correction encoding information, wherein the assistance information includes the forward error correction encoding information received from the application client.

7. The UE of claim 1, wherein the forward error correction encoding information is transmitted via an application function associated with the data packets to a policy control function of a core network.

8. The UE of claim 1, wherein the control signaling that schedules the transmission of the data packets associated with the traffic flow indicates a plurality of carriers, a plurality of cell groups, or a combination thereof, based at least in part on the forward error correction encoding information, and wherein, to transmit the data packets associated with the traffic flow, the one or more processors are individually or collectively operable to execute the code to cause the UE to:
transmit a first packet of the data packets in a first carrier of the plurality of carriers or a first cell group of the plurality of cell groups based at least in part on the control signaling and the forward error correction encoding information; and
transmit a second packet of the data packets in a second carrier of the plurality of carriers or a second cell group of the plurality of cell groups based at least in part on the control signaling and the forward error correction encoding information.

9. The UE of claim 1, wherein the control signaling that schedules the transmission of the data packets associated with the traffic flow indicates a plurality of transport blocks that are each associated with a respective multiple-input multiple-output (MIMO) communication layer based at least in part on the forward error correction encoding information and a capability of the UE to support MIMO operations, and wherein, to transmit the data packets associated with the traffic flow, the one or more processors are individually or collectively operable to execute the code to cause the UE to:
transmit a first data packet of the data packets in a first transport block of the plurality of transport blocks associated with a first MIMO communication layer based at least in part on the control signaling and the forward error correction encoding information; and
transmit a second data packet of the data packets in a second transport block of the plurality of transport blocks associated with a second MIMO communication layer based at least in part on the control signaling and the forward error correction encoding information.

10. The UE of claim 1, wherein the control signaling that schedules the transmission of the data packets associated with the traffic flow indicates a plurality of code blocks associated with one or more code block groups based at least in part on the forward error correction encoding information, wherein a first code block of the plurality of code blocks is associated with a first subcarrier and a second code block of the plurality of code blocks is associated with a second subcarrier, and wherein, to transmit the data packets associated with the traffic flow, the one or more processors are individually or collectively operable to execute the code to cause the UE to:
transmit a first data packet of the data packets in the first code block based at least in part on the control signaling and the forward error correction encoding information; and
transmit a second data packet of the data packets in the second code block based at least in part on the control signaling and the forward error correction encoding information.

11. The UE of claim 10, wherein the plurality of code blocks are associated with one or more transport blocks indicated by the control signaling.

12. The UE of claim 1, wherein:
the forward error correction encoding information comprises at least an identifier of the traffic flow and one or more encoding parameters of the data packets associated with the traffic flow;
the one or more encoding parameters of the data packets associated with the traffic flow is a ratio of a first quantity of data packets to a second quantity of forward error correction encoded packets used to communicate the data packets, and
the second quantity is larger than the first quantity.

13. The UE of claim 1, wherein, to transmit the data packets associated with the traffic flow, the one or more processors are individually or collectively operable to execute the code to cause the UE to:
transmit the data packets associated with the traffic flow amongst the transmission resources based at least in part on a hashing function associated with sequence numbers of the data packets.

14. The UE of claim 13, wherein the hashing function is based at least in part on a modulo operation performed on the sequence numbers of the data packets.

15. The UE of claim 14, wherein the modulo operation receives one or more carrier indices as inputs based at least in part on a plurality of carriers, a plurality of cell groups, or both, indicated by the control signaling.

16. The UE of claim 1, wherein, to transmit the data packets associated with the traffic flow, the one or more processors are individually or collectively operable to execute the code to cause the UE to:
transmit the data packets associated with the traffic flow amongst the quantity of the transmission resources based at least in part on a common probability factor that each data packet of the data packets will be transmitted within a transmission resource of the transmission resources, wherein the common probability factor is an inverse of a quantity of forward error correction encoded packets that carries the data packets.

17. The UE of claim 1, wherein, to transmit the data packets associated with the traffic flow, the one or more processors are individually or collectively operable to execute the code to cause the UE to:
transmit a first RLC segment of a data packet of the data packets in a remaining available portion of a transmission resource of the transmission resources based at least in part on a first size of the first RLC segment being equal to a second size of the remaining available portion; and
buffer one or more second RLC segments of the data packet for transmission in a second transmission resource indicated by second control signaling.

18. A network entity, comprising:
one or more memories storing processor-executable code; and
one or more processors coupled with the one or more memories and individually or collectively operable to execute the code to cause the network entity to:
obtain forward error correction encoding information for data packets associated with a traffic flow of a user equipment (UE), wherein the forward error correction encoding information indicates that the data packets associated with the traffic flow are encoded according to a forward error correction encoding scheme;
transmit control signaling that schedules communication of the data packets associated with the traffic flow for the UE based at least in part on the forward error correction encoding information; and
communicate the data packets associated with the traffic flow with the UE based at least in part on a quantity of transmission resources indicated by the control signaling for transmission of the data packets and the forward error correction encoding information.

19. The network entity of claim 18, wherein, to obtain the forward error correction encoding information, the one or more processors are individually or collectively operable to execute the code to cause the network entity to:
receive, from the UE, assistance information comprising the forward error correction encoding information;
receive, from a policy control function of a core network, an indication of the forward error correction encoding information via an application function associated with the data packets;
receive, from a user plane function of the core network, the forward error correction encoding information via a session management function of the core network; or
receive, from an access and mobility management function of the core network, the forward error correction encoding information via a network exposure function of the core network, the policy control function of the core network, or both.

20. A method for wireless communications at a user equipment (UE), comprising:
transmitting forward error correction encoding information for data packets associated with a traffic flow of the UE, wherein the forward error correction encoding information indicates that the data packets associated with the traffic flow are encoded according to a forward error correction encoding scheme;
receiving control signaling that schedules transmission of the data packets associated with the traffic flow to a network entity based at least in part on the forward error correction encoding information; and
transmitting the data packets associated with the traffic flow to the network entity based at least in part on a quantity of transmission resources indicated by the control signaling for transmission of the data packets and the forward error correction encoding information.
